(19) United States
(12) Patent Application Publication
(10) Pub. No.: US 2024/0091782 A1
(43) Pub. Date: Mar. 21, 2024

(54) FLOW CELLS

(71) Applicant: ILLUMINA CAMBRIDGE LIMITED, Cambridge (GB)

(72) Inventors: Timothy J. Merkel, Cambridge (GB); Wayne N. George, Ilford (GB); Andrew A. Brown, Cambridge (GB); Alexandre Richez, Cambourne (GB)

(21) Appl. No.: 18/455,090

(22) Filed: Aug. 24, 2023

Related U.S. Application Data
(60) Provisional application No. 63/373,610, filed on Aug. 26, 2022.

(51) Int. Cl. B01L 9/00

(52) U.S. Cl. CPC B01L 9/52

(57) ABSTRACT

An example of a flow cell includes a base support, a reversibly swellable resin positioned over the base support, and a depression defined in the reversibly swellable resin. The reversibly swellable resin includes at least one hydrophilic monomer selected from the group consisting of a poly(ethylene glycol) based monomer, poly(propylene glycol) based monomer, and combinations thereof. The depression has a first opening dimension when the reversibly swellable resin is in a non-swelled stated and has a second opening dimension, that is smaller than the first opening dimension, when the reversibly swellable resin is in a swelled state.

### CROSS-REFERENCE TO RELATED APPLICATION

This application claims the benefit of U.S. Provisional Application Ser. No. 63/373,610, filed Aug. 26, 2022, the contents of which is incorporated by reference herein in its entirety.

### REFERENCE TO SEQUENCE LISTING

The instant application contains a Sequence Listing which has been submitted electronically in XML format and is hereby incorporated by reference in its entirety. Said XML copy, created on Aug. 3, 2023, is named ILI246B_IP-2367-US_Sequence_Listing.xml, and is 15,626 bytes in size.

### BACKGROUND

Various protocols in biological or chemical research involve performing a large number of controlled reactions on local support surfaces or within predefined reaction chambers. The designated reactions may then be observed or detected and subsequent analysis may help identify or reveal properties of chemicals involved in the reaction. In some examples, the controlled reactions generate fluorescence, and thus an optical system may be used for detection.

### SUMMARY

The flow cells disclosed herein include a reversibly swellable resin that has single depth or multi-depth depressions, which are separated by interstitial regions, defined therein. The reversibly swellable resin is responsive to a stimulus, such as liquid and/or pH. When exposed to one of these stimuli, the resin swells. Because there is more resin material present at the interstitial regions than at the depressions, the interstitial regions expand at a greater rate than the depressions. The expansion of the interstitial regions causes the opening at each of the depressions to narrow. The removal of the stimulus or the application of an orthogonal stimulus causes the resin to de-swell or contract.

In some examples of the flow cell, the reversibly swellable resin is swelled to trap pre-clustered or grafted particles for further chemical and/or biochemical manipulations, and is de-swelled to release the particles at a desirable time. In other examples of the flow cell, the reversibly swellable resin is swelled prior to nucleic acid template seeding. The smaller depression openings minimize multiple seeding events from taking place in a single depression, thus reducing polyclonality.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a top view of an example flow cell;

FIG. 2A is a cross sectional view taken along line 2A-2A of FIG. 1 illustrating the architecture within a flow channel of one example of the flow cell disclosed herein including single depth depressions defined in a reversibly swellable resin;

FIG. 2B depicts the architecture of FIG. 2A after pre-clustered particles have been introduced to the flow channel of the flow cell and the reversibly swellable resin is exposed to a stimulus;

FIG. 3A is a cross sectional view taken along line 3A-3A of FIG. 1 illustrating the architecture within a flow channel of another example of the flow cell disclosed herein including single depth depressions defined in a reversibly swellable resin;

FIG. 3B depicts the architecture of FIG. 3A after a template strand has been introduced to the flow cell and the reversibly swellable resin is exposed to a stimulus;

FIG. 4A is a cross sectional view taken along line 4A-4A of FIG. 1 illustrating the architecture within a flow channel of still another example of the flow cell disclosed herein including multi-depth depressions defined in a reversibly swellable resin;

Each of FIGS. 4B through 4D schematically depicts the architecture of FIG. 4A at different stages during fabrication of the patterned structure, and together illustrate a flow diagram involving the architecture of FIG. 4A, where grafted particles are introduced into the flow cell and the reversibly swellable resin is exposed to a stimulus (FIG. 4B), where a functionalized layer is incorporated into the flow cell (FIG. 4C), and where interstitial regions are cleaned (FIG. 4D); and

FIG. 5A, FIG. 5B, FIG. 5C, and FIG. 5D each depict schematic views of different grafted particles and pre-grafted polymers that can be used together in an example of a flow cell.

### DETAILED DESCRIPTION

The flow cells disclosed herein include a reversibly swellable resin. The reversibly swellable resin has single depth or multi-depth depressions patterned therein. In some examples, each single depth depression is separated from each other single depth depression by interstitial regions, or each multi-depth depression is separated from each other multi-depth depression by interstitial regions. In other examples, the multi-depth depressions are formed adjacent to one another without interstitial regions separating the depressions. The reversibly swellable resin swells when exposed a stimulus, and de-swells or contracts upon removal of the stimulus or the application of an orthogonal stimulus. In some examples of the flow cell, the reversibly swellable resin is swelled to trap pre-clustered particles for synthesis, and is de-swelled to release the sequenced particles. In other examples of the flow cell, the reversibly swellable resin is swelled prior to nucleic acid template seeding. The smaller depression openings minimize multiple seeding events from taking place in a single depression, thus reducing polyclonality.

### Definitions

It is to be understood that terms used herein will take on their ordinary meaning in the relevant art unless specified otherwise. Several terms used herein and their meanings are set forth below.

The singular forms “a”, “an”, and “the” include plural referents unless the context clearly dictates otherwise.

The terms comprising, including, containing and various forms of these terms are synonymous with each other and are meant to be equally broad.

The terms top, bottom, lower, upper, on, etc. are used herein to describe the flow cell and/or the various components of the flow cell. It is to be understood that these directional terms are not meant to imply a specific orientation, but are used to designate relative orientation between components. The use of directional terms should not be interpreted to limit the examples disclosed herein to any specific orientation(s).

The terms first, second, etc. also are not meant to imply a specific orientation or order, but rather are used to distinguish one component from another.

It is to be understood that the ranges provided herein include the stated range and any value or sub-range within the stated range, as if such values or sub-ranges were explicitly recited. For example, a range of about 400 nm to about 1 μm (1000 nm), should be interpreted to include not only the explicitly recited limits of about 400 nm to about 1 μm, but also to include individual values, such as about 708 nm, about 945.5 nm, etc., and sub-ranges, such as from about 425 nm to about 825 nm, from about 550 nm to about 940 nm, etc. Furthermore, when “about” and/or “substantially” are/is utilized to describe a value, they are meant to encompass minor variations (up to +/−10%) from the stated value.

An “acrylamide monomer” is a monomer with the structure

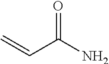

or a monomer including an acrylamide group. Examples of the monomer including an acrylamide group include azido acetamido pentyl acrylamide:

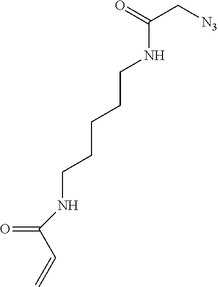 [SMILES: C=CC(=O)NCCCCCNC(=O)CN=[N+]=[N-]]

### and N-isopropylacrylamide:

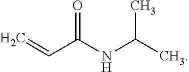

Other acrylamide monomers may be used.

The term “activation,” as used herein, refers to a process that generates reactive groups at the surface of a base support or an outermost layer of a multi-layered structure. Activation may be accomplished using silanization and/or plasma ashing. As examples, a surface may have a silane (e.g., norbornene silane) added thereto; or a surface may be plasma ashed to generate hydroxyl groups; or a surface may be plasma ashed and then silanized. While the figures do not depict a separate silanized layer or hydroxyl (—OH groups) from plasma ashing, it is to be understood that activation generates a silanized layer or —OH groups at the surface of the activated support or layer to covalently attach the functionalized layers to the underlying support or layer.

An aldehyde, as used herein, is an organic compound containing a functional group with the structure —CHO, which includes a carbonyl center (i.e., a carbon double-bonded to oxygen) with the carbon atom also bonded to hydrogen and an R group, such as an alkyl or other side chain. The general structure of an aldehyde is:

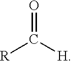

As used herein, “alkyl” refers to a straight or branched hydrocarbon chain that is fully saturated (i.e., contains no double or triple bonds). The alkyl group may have 1 to 20 carbon atoms. Example alkyl groups include methyl, ethyl, propyl, isopropyl, butyl, isobutyl, tertiary butyl, pentyl, hexyl, and the like. As an example, the designation “C1-4 alkyl” indicates that there are one to four carbon atoms in the alkyl chain, i.e., the alkyl chain is selected from the group consisting of methyl, ethyl, propyl, iso-propyl, n-butyl, isobutyl, sec-butyl, and t-butyl.

As used herein, “alkenyl” refers to a straight or branched hydrocarbon chain containing one or more double bonds. The alkenyl group may have 2 to 20 carbon atoms. Example alkenyl groups include ethenyl, propenyl, butenyl, pentenyl, hexenyl, and the like.

As used herein, “alkyne” or “alkynyl” refers to a straight or branched hydrocarbon chain containing one or more triple bonds. The alkynyl group may have 2 to 20 carbon atoms.

As used herein, “aryl” refers to an aromatic ring or ring system (i.e., two or more fused rings that share two adjacent carbon atoms) containing only carbon in the ring backbone. When the aryl is a ring system, every ring in the system is aromatic. The aryl group may have 6 to 18 carbon atoms. Examples of aryl groups include phenyl, naphthyl, azulenyl, and anthracenyl.

An “amine” or “amino” functional group refers to an —NRₐR_{b} group, where Rₐ and R_{b} are each independently selected from hydrogen (e.g.,

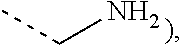

C1-6 (or C1-C6) alkyl, C2-6 alkenyl, C2-6 alkynyl, C3-7 carbocycle, C6-10 aryl, 5-10 membered heteroaryl, and 5-10 membered heterocyclyl, as defined herein.

As used herein, the term “attached” refers to the state of two things being joined, fastened, adhered, connected or bound to each other, either directly or indirectly. As examples, bonds that form may be covalent or non-covalent. A covalent bond is characterized by the sharing of pairs of electrons between atoms. A non-covalent bond is a physical bond that does not involve the sharing of pairs of electrons and can include, for example, hydrogen bonds, ionic bonds, van der Waals forces, hydrophilic interactions and hydrophobic interactions.

An “azide” or “azido” functional group refers to —N₃.

The term “base support” refers to a structure upon which various components of the flow cell (e.g., the reversibly swellable resin) may be added. The base support may be a wafer, a panel, a rectangular sheet, a die, or any other suitable configuration. The base support is generally rigid and is insoluble in an aqueous liquid. The base support may be inert to the chemistry that is present in the depressions. For example, a base support can be inert to chemistry used to attach the primer(s), used in sequencing reactions, etc. The base support may be a single or multi-layered structure.

As used herein, “carbocycle” means a non-aromatic cyclic ring or ring system containing only carbon atoms in the ring system backbone. When the carbocycle is a ring system, two or more rings may be joined together in a fused, bridged or spiro-connected fashion. Carbocycles may have any degree of saturation, provided that at least one ring in a ring system is not aromatic. Thus, carbocycles include cycloalkyls, cycloalkenyls, and cycloalkynyls. The carbocycle group may have 3 to 20 carbon atoms. Examples of carbocycle rings include cyclopropyl, cyclobutyl, cyclopentyl, cyclohexyl, cyclohexenyl, 2,3-dihydro-indene, bicyclo[2.2.2]octanyl, adamantyl, and spiro[4.4]nonanyl.

As used herein, the term “carboxylic acid” or “carboxyl” as used herein refers to —COOH.

As used herein, “cycloalkylene” means a fully saturated carbocycle ring or ring system that is attached to the rest of the molecule via two points of attachment.

As used herein, “cycloalkenyl” or “cycloalkene” means a carbocycle ring or ring system having at least one double bond, wherein no ring in the ring system is aromatic. Examples include cyclohexenyl or cyclohexene and norbornenyl or norbornene. Also as used herein, “heterocycloalkenyl” or “heterocycloalkene” means a carbocycle ring or ring system with at least one heteroatom in ring backbone, having at least one double bond, wherein no ring in the ring system is aromatic.

As used herein, “cycloalkynyl” or “cycloalkyne” means a carbocycle ring or ring system having at least one triple bond, wherein no ring in the ring system is aromatic. An example is cyclooctyne. Another example is bicyclononyne. Also as used herein, “heterocycloalkynyl” or “heterocycloalkyne” means a carbocycle ring or ring system with at least one heteroatom in ring backbone, having at least one triple bond, wherein no ring in the ring system is aromatic.

As used herein, the terms “deep portion” and “shallow portion” refer to three-dimensional (3D) spaces within a multi-depth depression. In the multi-depth depression, the deep portion has a greater depth than the shallow portion, as measured, e.g., from an opening of the multi-depth depression.

The term “depositing,” as used herein, refers to any suitable application technique, which may be manual or automated, and, in some instances, results in modification of the surface properties. Generally, depositing may be performed using vapor deposition techniques, coating techniques, grafting techniques, or the like. Some specific examples include chemical vapor deposition (CVD), spray coating (e.g., ultrasonic spray coating), spin coating, dunk or dip coating, doctor blade coating, puddle dispensing, flow through coating, aerosol printing, screen printing, microcontact printing, inkjet printing, or the like.

As used herein, the term “depression” refers to a discrete concave feature in a substrate having a surface opening that may be at least partially surrounded by interstitial region(s) of the substrate. Depressions can have any of a variety of shapes at their opening in a surface including, as examples, round, elliptical, square, polygonal, star shaped (with any number of vertices), etc. The cross-section of a depression taken orthogonally with the surface can be curved, square, polygonal, hyperbolic, conical, angular, etc.

The term “each,” when used in reference to a collection of items, is intended to identify an individual item in the collection, but does not necessarily refer to every item in the collection. Exceptions can occur if explicit disclosure or context clearly dictates otherwise.

The term “epoxy” (also referred to as a glycidyl or oxirane group) as used herein refers to

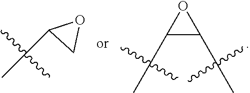

As used herein, the term “flow cell” is intended to mean a vessel having a flow channel where a reaction can be carried out, an inlet for delivering reagent(s) to the flow channel, and an outlet for removing reagent(s) from the flow channel. In some examples, the flow cell enables the detection of the reaction that occurs in the chamber. For example, the flow cell may include one or more transparent surfaces allowing for the optical detection of arrays, optically labelled molecules, or the like within the flow channel.

As used herein, a “flow channel” or “channel” may be an area defined between two bonded components, which can selectively receive a liquid sample. In some examples, the flow channel may be defined between a substrate and a lid, and thus may be in fluid communication with one or more depressions defined in the substrate. The flow channel may also be defined between two substrate surfaces that are bonded together.

As used herein, “heteroaryl” refers to an aromatic ring or ring system (i.e., two or more fused rings that share two adjacent atoms) that contain(s) one or more heteroatoms, that is, an element other than carbon, including but not limited to, nitrogen, oxygen and sulfur, in the ring backbone. When the heteroaryl is a ring system, every ring in the system is aromatic. The heteroaryl group may have 5-18 ring members.

As used herein, “heterocycle” means a non-aromatic cyclic ring or ring system containing at least one heteroatom in the ring backbone. Heterocycles may be joined together in a fused, bridged or spiro-connected fashion. Heterocycles may have any degree of saturation provided that at least one ring in the ring system is not aromatic. In the ring system, the heteroatom(s) may be present in either a non-aromatic or aromatic ring. The heterocycle group may have 3 to 20 ring members (i.e., the number of atoms making up the ring backbone, including carbon atoms and heteroatoms).

The term “hydrazine” or “hydrazinyl” as used herein refers to a —NHNH₂ group.

As used herein, the term “hydrazone” or “hydrazonyl” as used herein refers to a

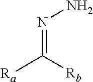

group in which Rₐ and R_{b} are each independently selected from hydrogen, C1-6 alkyl, C2-6 alkenyl, C2-6 alkynyl, C3-7 carbocycle, C6-10 aryl, 5-10 membered heteroaryl, and 5-10 membered heterocycle, as defined herein.

As used herein, “hydroxy” or “hydroxyl” refers to an —OH group.

As used herein, an “initiator” is a molecule that undergoes a reaction upon absorption of radiation or heat or upon exposure to free radicals, thereby producing a reactive species. Initiators are capable of initiating or catalyzing chemical reactions that result in changes in the solubility and/or physical properties of formulations. A “cationic initiator” or “photoacid generator” (PAG) is a molecule that becomes acidic upon exposure to radiation or to free radicals. PAGs generally undergo proton photodissociation irreversibly. A “free radical initiator” is a molecule that generates a radical species upon exposure to radiation or heat and that promotes radical reactions.

As used herein, the term “interstitial region” refers to an area, e.g., of a substrate that separates depressions. For example, an interstitial region can separate one depression of an array from another depression of the array. The two depressions that are separated from each other can be discrete, i.e., lacking physical contact with each other. In many examples, the interstitial region is continuous whereas the depressions are discrete, for example, as is the case for a plurality of depressions defined in an otherwise continuous surface. The separation provided by an interstitial region can be partial or full separation.

A “lid” refers to a cover that can be attached to a patterned structure to form a flow cell.

The term “polymeric hydrogel” refers to a semi-rigid polymer that is permeable to liquids and gases. The polymeric hydrogel can swell when liquid (e.g., water) is taken up and that can contract when liquid is removed, e.g., by drying. While a hydrogel may absorb water, it is not water-soluble.

“Nitrile oxide,” as used herein, means a “RₐC≡N⁺O⁻” group in which Rₐ is defined herein. Examples of preparing nitrile oxide include in situ generation from aldoximes by treatment with chloramide-T or through action of base on imidoyl chlorides [RC(Cl)═NOH] or from the reaction between hydroxylamine and an aldehyde.

“Nitrone,” as used herein, means a

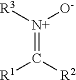

group in which R¹, R², and R³ may be any of the Rₐ and R_{b} groups defined herein, except that R³ is not hydrogen (H).

As used herein, a “nucleotide” includes a nitrogen containing heterocyclic base, a sugar, and one or more phosphate groups. Nucleotides are monomeric units of a nucleic acid sequence. In ribonucleic acids (RNA), the sugar is a ribose, and in deoxyribonucleic acids (DNA), the sugar is a deoxyribose, i.e., a sugar lacking a hydroxyl group that is present at the 2′ position in ribose. The nitrogen containing heterocyclic base (i.e., nucleobase) can be a purine base or a pyrimidine base. Purine bases include adenine (A) and guanine (G), and modified derivatives or analogs thereof. Pyrimidine bases include cytosine (C), thymine (T), and uracil (U), and modified derivatives or analogs thereof. The C-1 atom of deoxyribose is bonded to N-1 of a pyrimidine or N-9 of a purine. A nucleic acid analog may have any of the phosphate backbone, the sugar, or the nucleobase altered. Examples of nucleic acid analogs include, for example, universal bases or phosphate-sugar backbone analogs, such as peptide nucleic acid (PNA).

The term “orthogonal,” when used to describe two stimuli, means that the stimuli are different from each other and have different effects on the reversibly swellable resin. One stimulus may be used to induce swelling and the other stimulus may be used to reduce swelling, i.e., induce non-swelling.

In some examples, the term “over” may mean that one component or material is positioned directly on another component or material. In other examples, the term “over” may mean that one component or material is positioned indirectly on another component or material. By indirectly on, it is meant that a gap or an additional component or material may be positioned between the two components or materials.

As used herein, the term “polyhedral oligomeric silsesquioxane” refers to a chemical composition that is a hybrid intermediate (e.g., RSiO_{1.5}) between that of silica (SiO₂) and silicone (R₂SiO). An example of polyhedral oligomeric silsesquioxane may be that described in Kehagias et al., Microelectronic Engineering 86 (2009), pp. 776-778, which is incorporated by reference in its entirety. In an example, the composition is an organosilicon compound with the chemical formula [RSiO_{3/2}]ₙ, where the R groups can be the same or different. Example R groups for polyhedral oligomeric silsesquioxane include epoxy, azide/azido, a thiol, a poly(ethylene glycol), a norbornene, a tetrazine, acrylates, and/or methacrylates, or further, for example, alkyl, aryl, alkoxy, and/or haloalkyl groups.

As used herein, the term “primer” is defined as a single stranded nucleic acid sequence (e.g., single strand DNA). Some primers are part of a primer set, which serve as a starting point for template amplification and cluster generation. Other primers, referred to herein as sequencing primers, serve as a starting point for DNA synthesis. The 5′ terminus of each primer in a primer set may be modified to allow a coupling reaction with a functional group of a polymer chain. The primer length can be any number of bases long and can include a variety of non-natural nucleotides. In an example, the sequencing primer is a short strand, ranging from 10 to 60 bases, or from 20 to 40 bases.

The term “primer set” refers to a pair of primers that together enable the amplification of a template nucleic acid strand (also referred to herein as a library template). Opposed ends of the template strand include adapters to hybridize to the respective primers in a set.

A “thiol” functional group refers to —SH.

As used herein, the terms “tetrazine” and “tetrazinyl” refer to six-membered heteroaryl group comprising four nitrogen atoms. Tetrazine can be optionally substituted.

“Tetrazole,” as used herein, refer to five-membered heterocyclic group including four nitrogen atoms. Tetrazole can be optionally substituted.

The term “transparent” refers to a material, e.g., in the form of a layer, that is capable of transmitting a particular wavelength or range of wavelengths. For example, the material may be transparent to wavelength(s) that are used in a sequencing operation. Transparency may be quantified using transmittance, i.e., the ratio of light energy falling on a body to that transmitted through the body. The transmittance of a transparent layer will depend upon the thickness of the layer, the wavelength of light, and the dosage of the light to which it is exposed. In the examples disclosed herein, the transmittance of the transparent metal layer may range from 0.1 (10%) to 1 (100%). The material of the transparent metal layer may be a pure material, a material with some impurities, or a mixture of materials, as long as the resulting layer is capable of the desired transmittance.

### Reversibly Swellable Resin

The reversibly swellable resin is an ultraviolet light cured resin that is capable of swelling in the presence of a particular stimulus, and is capable of de-swelling, and thus contracting, when the stimulus is removed or when the resin is exposed to another orthogonal stimulus. The monomeric units of the composition used to form the cured resin impart the cured resin with desirable characteristics, including its swellability.

At least one hydrophilic monomer is included to increase the hydrophilicity of the cured resin surface, which, in turn, increases the swellability of the cured resin. In one example, the hydrophilic monomer(s) is/are selected from the group consisting of a poly(ethylene glycol) based monomer, poly(propylene glycol) based monomer, an acid-containing monomer, and combinations thereof.

The poly(ethylene glycol) based monomer is a monomer or a macromonomer having from 2 to about 1,000 of the ethylene glycol units. In other words, the poly(ethylene glycol) has a number average molecular weight ranging from about 300 to about 20,000. In one example, the number average molecular weight ranges from about 300 to about 5,000. Some specific examples of suitable poly(ethylene glycol) based monomers include ethylene glycol diglycidyl ether, poly(ethylene glycol) (400) diglycidyl ether, or poly(ethylene glycol) (1000) diglycidyl ether. The poly(propylene glycol) based monomer is a monomer or a macromonomer having from 2 to about 1,000 of the ethylene glycol units. In other words, the poly(propylene glycol) has a number average molecular weight ranging from about 300 to about 20,000, and in some examples, from about 300 to about 5,000. Some specific examples of suitable poly(propylene glycol) based monomers include propylene glycol diglycidyl ether, poly(propylene glycol) (600) diglycidyl ether, or poly(propylene glycol) (1000) diglycidyl ether. The number average molecular weight of the poly(ethylene glycol) and/or the poly(propylene glycol) may be tuned to adjust the hydrophilicity and/or swellability of the resin. When used in combination, the weight ratio of poly(ethylene glycol) (PEG) and poly(propylene glycol) (PPG) may be tuned to adjust the hydrophilicity and/or swellability of the resin. More PEG will increase the swelling, so a higher molecular weight PEG should increase the extent of swelling. In contrast, the solubility of PPG in water decreases with increasing molecular weight. Thus, varying the ratio and/or molecular weights can adjust the swellability.

The acid-containing monomer is a monomer that includes one or more carboxylic acid/carboxylate or sulfonic acid/sulfonate groups that become deprotonated at high pH (e.g., from about 9 to about 10), rendering it anionic and swellable.

In an example, the monomer(s) used to form the reversibly swellable resin consist of the hydrophilic monomer(s). In this example, 100% (by mass) of the monomers that are polymerized to form the resin composition are the hydrophilic monomer(s). In other examples, the hydrophilic monomer is copolymerized with another monomer or polymer, which may be selected to introduce attachment functional groups or to improve the imprintability of the resin. When other monomer(s) or polymer(s) are used with the hydrophilic monomer(s), the resin may include from about 0.5% (by mass) to 50% (by mass) of the hydrophilic monomer(s), based on the total solids of the resin composition. In some instances, the resin composition may include from about 0.5% (by mass) to 20% (by mass) of the hydrophilic monomer(s), based on the total solids of the resin composition. The higher percentage of hydrophilic monomers, e.g., from about 20% to about 50%, may be particularly suitable when polishing is not involved in the application of the polymeric hydrogel.

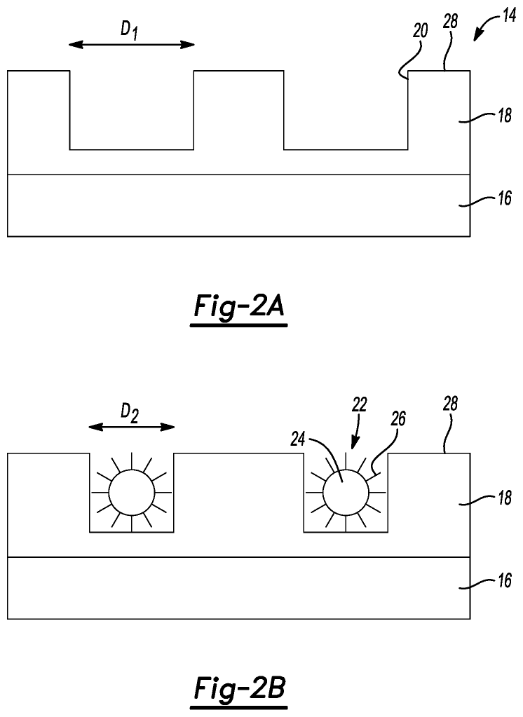

In some examples, an additional monomer is included in the resin composition to introduce functional groups to the cured resin that are capable of attaching to a polymeric hydrogel or to primers. When the polymeric hydrogel is to, or the primers are to, be covalently attached to the reversibly swellable resin (see FIG. 2A), the additional monomer that is copolymerized with the hydrophilic monomer includes a functional group to covalently attach to the polymeric hydrogel or to the primers. In one specific example, the functional group is selected from the group consisting of an alkyne, a diene (e.g., in the form of a ring-strained alkene), an azide, and an amine. Examples of monomers that may be used to introduce covalently linkable functional groups include glycidyl propargyl ether:

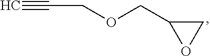

methyl-5-norbornene-2,3-dicarboxylic anhydride:

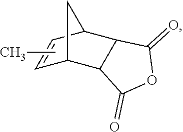

Bicyclo[2.2.1]hept-5-ene-2,3-dicarboxylic anhydride:

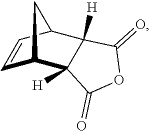

3-Azido-1-propanol:

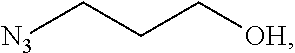

11-Azido-3,6,9-trioxaundecan-1-amine:

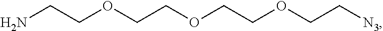 [SMILES: [N-]=[N+]=NCCOCCOCCOCCN]

propiolic acid:

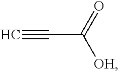

and combinations thereof.

The polymeric hydrogel can non-covalently interact with examples of the reversibly swellable resin containing less than 20% by mass of the hydrophilic monomer, without any additional functionality being added to the polymeric hydrogel.

Each monomer(s) that introduces attachment functional groups may be included in an amount ranging from about 2% (by mass) to about 50% (by mass), based on the total solids of the resin composition.

Examples of monomers or polymers that may improve the imprintability of the resin composition are hydrophobic monomers or polymers that include epoxy or acrylate groups.

Examples of suitable hydrophobic monomers include epoxy substituted silsesquioxane monomers, such as epoxycyclohexylethyl polysilsesquioxane:

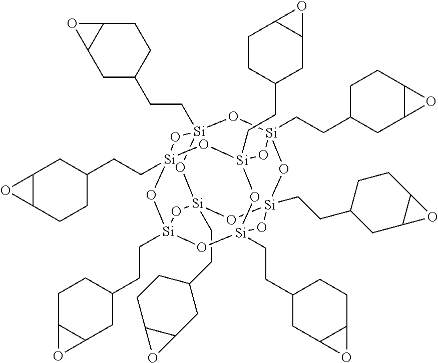 [SMILES: C1CC2OC2CC1CC[Si]12O[Si]3(CCC4CCC5OC5C4)O[Si]4(CCC5CCC6OC6C5)O[Si](CCC5CCC6OC6C5)(O1)O[Si]1(CCC5CCC6OC6C5)O[Si](CCC5CCC6OC6C5)(O2)O[Si](CCC2CCC5OC5C2)(O3)O[Si](CCC2CCC3OC3C2)(O4)O1]

glycidyl polysilsesquioxane:

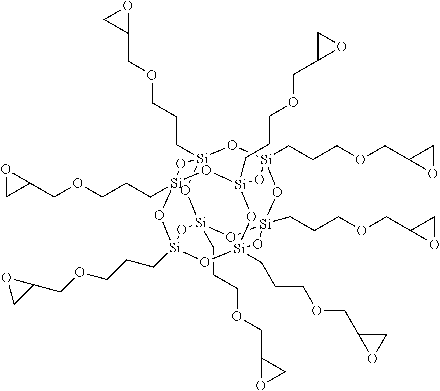 [SMILES: C(COCC1CO1)C[Si]12O[Si]3(CCCOCC4CO4)O[Si]4(CCCOCC5CO5)O[Si](CCCOCC5CO5)(O1)O[Si]1(CCCOCC5CO5)O[Si](CCCOCC5CO5)(O2)O[Si](CCCOCC2CO2)(O3)O[Si](CCCOCC2CO2)(O4)O1]

and combinations thereof. One example of the resin composition includes both epoxycyclohexylethyl polysilsesquioxane and glycidyl polysilsesquioxane present at a mass ratio ranging from about 3:7 to about 7:3. In one specific example, the mass ratio of the epoxycyclohexylethyl polysilsesquioxane and the glycidyl polysilsesquioxane is 1.5:1.

An example of a suitable hydrophobic polymer includes an acrylate substituted polyhedral oligomeric silsesquioxane polymer, such as Poly[(propylmethacryl-heptaisobutyl-polyhedral oligomeric silsesquioxane)-co-(t-butyl methacrylate)]:

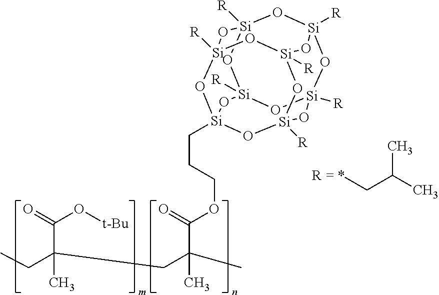

Each monomer(s) or polymer that improves the imprintability may be included in an amount ranging from about 2% (by mass) to about 50% (by mass), based on the total solids of the resin composition.

Still another example monomer that may be copolymerized with the hydrophilic monomer(s) enables the cured resin to attach, e.g., covalently, to the underlying base support. An example of this monomer is a reactive silane, such as epoxy silane, which can attach to the base support through an oxygen linkage. This type of monomer may be desirable with the acrylo-based resin formulations.

Each monomer(s) that enables attachment to the base support may be included in an amount ranging from about 2% (by weight) to about 50% (by weight), based on the total solids of the resin composition.

The resin composition used to form the reversibly swellable resin may also include a photoinitiator, a surface additive, and a solvent.

The photoinitiator is selected from the group consisting of a free radical photoinitiator, a cationic photoinitiator, and combinations thereof. Examples of the free radical initiator are selected from the group consisting of 1,1,2,2-tetraphenyl-1,2-ethanediol:

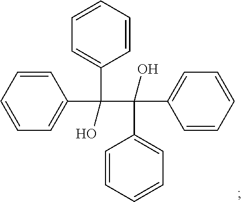 [SMILES: OC(c1ccccc1)(c1ccccc1)C(O)(c1ccccc1)c1ccccc1]

ethyl pyruvate:

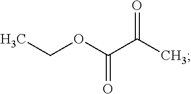

thiol; ethyl-3-methyl-2-oxobutanoate:

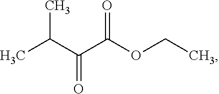

and combinations thereof. Examples of the cationic initiator are selected from the group consisting of bis-(4-methylphenyl)iodonium hexafluorophosphate:

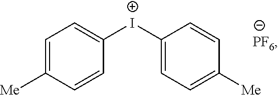

bis[4-(tert-butyl)phenyl]iodonium tetra(nonafluoro-tert-butoxy)aluminate:

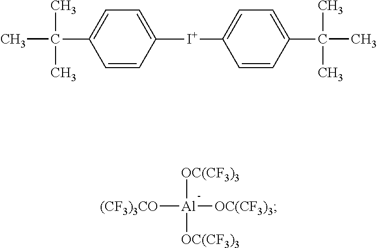

tris(4-((4-acetylphenyl)thio)phenyl)-sulfonium tetrakis(perfluoro-phenyl)borate (PAG 290):

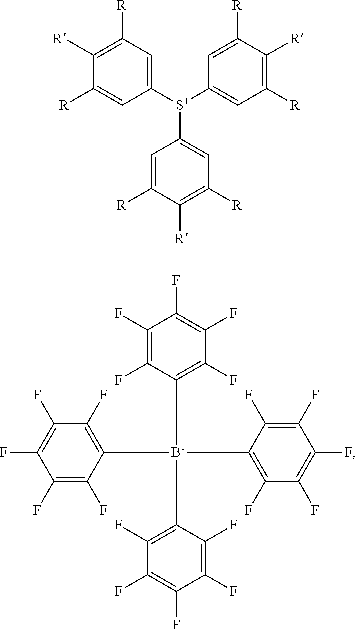

where R is

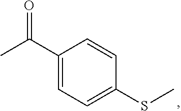

and combinations thereof.

In an example of the resin composition, the photoinitiator (or each photoinitiator if a combination is used) is present in an amount ranging from about 0.05 mass % to about 10 mass %, based on a total solids content of the resin composition. In another example, the photoinitiator is present in an amount ranging from about 0.2 mass % to about 8 mass %.

The surface additive can adjust the surface tension of the resin composition, which can improve the coatability of the resin composition, promote thin film stability, and/or improve leveling. Examples of surface additives include polyacrylate polymers (such as BYK®-350 available from BYK). The amount of the surface additive may be 5 mass % or less, based on the total mass of the resin composition.

The resin composition disclosed herein may also include a solvent. The solvent may be added to the resin composition to achieve a desired viscosity for the deposition technique being used to apply the resin composition and to obtain a desired resin layer thickness. Examples of suitable solvents include propylene glycol monomethyl ether acetate (PGMEA), toluene, dimethyl sulfoxide (DMSO), tetrahydrofuran (THF), etc. In some examples, the solvent is PGMEA.

Once the solvent is added, the total solids concentration of the resin composition may range from about 15 mass % to about 60 mass % (based on the total mass of the resin composition), and the amount of solvent may range from about 40 mass % to about 85 mass % (based on the mass of the resin composition). The upper limits of the total solids may be higher depending upon the respective solubility of the solid component(s) in the solvent that is selected. In some examples, the solid content is about 30% or less.

To generate the resin composition, the various components may be mixed together in any desirable order. One example of a method for making any example of the resin composition disclosed herein includes mixing the monomer(s) (e.g., at least the hydrophilic monomer) with the initiator(s) and the surface additive, and dissolving the mixture in the solvent.

The resin composition is ultraviolet light curable. In one example, a 365 nm UV light source may be used to cure the resin composition to form the reversibly swellable resin.

### Flow Cells and Methods

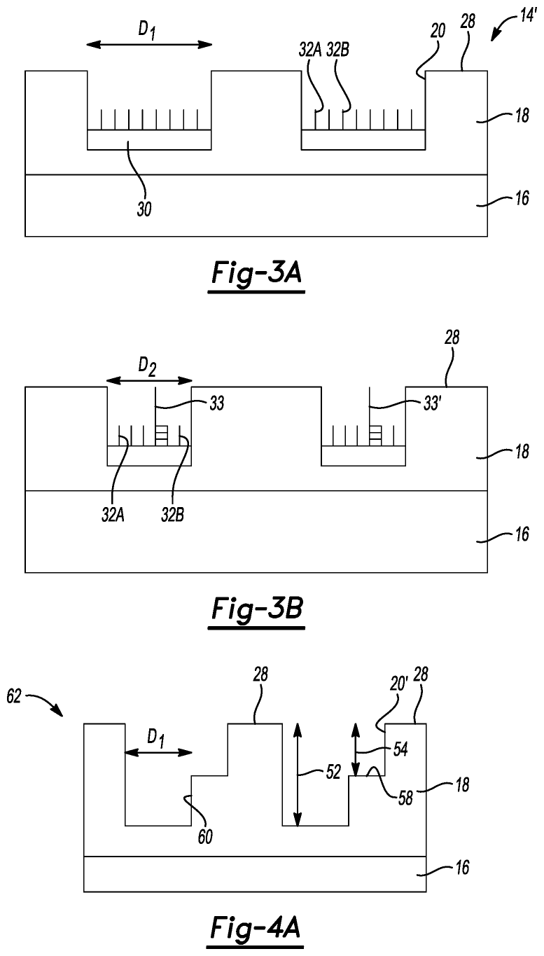

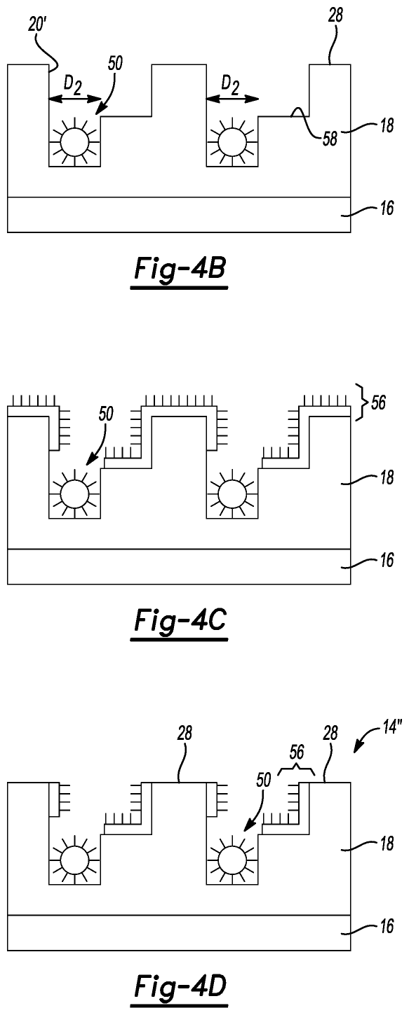

The reversibly swellable resin disclosed herein may be incorporated into a patterned structure, which is used to form a flow cell. Different examples of the patterned structures are shown and described in reference to FIG. 2A and FIG. 2B, FIG. 3A and FIG. 3B, and FIG. 4A through FIG. 4D.

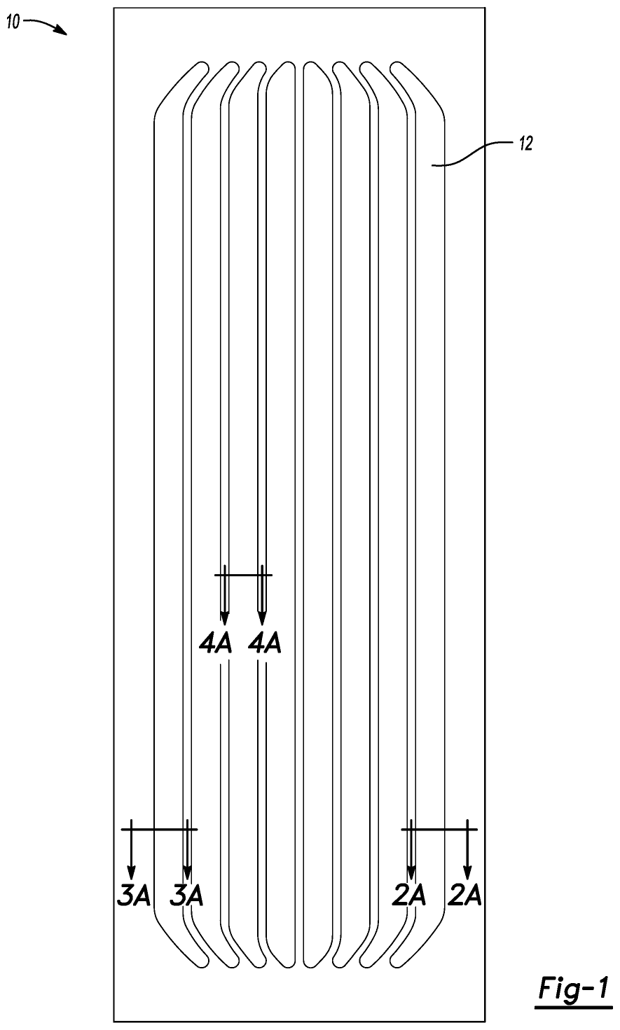

A top view of each example flow cell 10 is shown in FIG. 1. The flow cell 10 may be an open wafer (i.e., no lid or second patterned structure), or may include two patterned structures bonded together, or may include one patterned structure bonded to a lid. The two patterned structures or the one patterned structure and the lid may be attached to one another through a spacer layer (not shown). The spacer layer may be any material that will seal portions of the patterned structures together or portions of the patterned structure and the lid. As examples, the spacer layer may be an adhesive, a radiation-absorbing material that aids in bonding, or the like. In some examples, the spacer layer is the radiation-absorbing material, e.g., KAPTON® black. The patterned structures or the patterned structure and the lid may be bonded using any suitable technique, such as laser bonding, diffusion bonding, anodic bonding, eutectic bonding, plasma activation bonding, glass frit bonding, or others methods known in the art.

When a lid is used, the lid may be any material that is transparent to the excitation light that is used in sequencing. In optical detection systems, the lid may also be transparent to the emissions generated from reaction(s) taking place within the flow cell 10. As examples, the lid may include glass (e.g., borosilicate, fused silica, etc.) or a transparent polymer. A commercially available example of a suitable borosilicate glass is D 263®, available from Schott North America Inc. Commercially available examples of suitable polymer materials, namely cyclo olefin polymers, are the ZEONOR® products available from Zeon Chemicals L.P.

Between the two patterned structures or the one patterned structure and the lid is a flow channel 12. In examples with an open wafer, the flow channel 12 may be defined in a base support 16, and a patterned resin (e.g., resin 18) may be positioned within that flow channel. In this example, the flow channel 12 is not enclosed, but rather is open. The example shown in FIG. 1 includes eight flow channels 12. While eight flow channels 12 are shown, it is to be understood that any number of flow channels 12 may be included in the flow cell 10 (e.g., a single flow channel 12, four flow channels 12, etc.). When multiple flow channels 12 are included, each flow channel 12 may be isolated from each other flow channel 12 so that fluid introduced into one flow channel 12 does not flow into adjacent flow channel(s) 12. Some examples of the fluids introduced into the flow channel 12 may introduce reaction components (e.g., a DNA sample, polymerases, sequencing primers, nucleotides, etc.), washing solutions, deblocking agents, etc.

The flow channel 12 may have any desirable shape. In an example, the flow channel 12 has a substantially rectangular configuration. The length of the flow channel 12 depends, in part, upon the size of the base support of the patterned structure. The width of the flow channel 12 depends, in part, upon the size of the base support of the patterned structure, the desired number of flow channels 12, the desired space between adjacent channels 12, and the desired space at a perimeter of the patterned structure.

The height of the flow channel 12 can be as small as a monolayer thick when microcontact, aerosol, or inkjet printing is used to deposit a separate material that defines the flow channel 12 walls. As other examples, the height of the flow channel 12 can be about 1 μm, about 10 μm, about 50 μm, about 100 μm, or more. In an example, the height may range from about 10 μm to about 100 μm. In another example, the height may range from about 10 μm to about 30 μm. In still another example, the height is about 5 μm or less. It is to be understood that the height of the flow channel 12 may be greater than, less than or between the values specified above.

Each flow channel 12 is in fluid communication with an inlet and an outlet (not shown). The inlet and outlet of each flow channel 12 may be positioned at opposed ends of the flow cell 10. The inlets and outlets of the respective flow channels 12 may alternatively be positioned anywhere along the length and width of the flow channel 12 that enables desirable fluid flow.

The inlet allows fluid(s) to be introduced into the flow channel 12, and the outlet allows fluid(s) to be extracted from the flow channel 12. Each of the inlets and outlets is fluidly connected to a fluidic control system (including, e.g., reservoirs, pumps, valves, waste containers, and the like) which controls fluid introduction and expulsion.

FIG. 2A, FIG. 3A, and FIG. 4D depict different examples of the patterned structure 14, 14′, 14″, and thus depict different examples of the architecture within the flow channel 12 of the flow cell 10.

### First Example Flow Cell and Method

The patterned structure 14 in the first example of the flow cell 10 includes a base support 16; the reversibly swellable resin 18 positioned over the base support; and a depression 20 defined in the reversibly swellable resin 18, the depression 20 having a first opening dimension Di when the reversibly swellable resin 18 is in a non-swelled stated (FIG. 2A) and having a second opening dimension D₂, that is smaller than the first opening dimension D₁, when the reversibly swellable resin 18 is in a swelled stated (FIG. 2B).

Examples of the base support 16 include epoxy siloxane, glass, modified or functionalized glass, plastics (including acrylics, polystyrene and copolymers of styrene and other materials, polypropylene, polyethylene, polybutylene, polyurethanes, polytetrafluoroethylene (such as TEFLON® from Chemours), cyclic olefins/cyclo-olefin polymers (COP) (such as ZEONOR® from Zeon), polyimides, nylon (polyamides), etc.), ceramics/ceramic oxides, silica, fused silica, or silica-based materials, aluminum silicate, silicon and modified silicon (e.g., boron doped p+ silicon), silicon nitride (Si₃N₄), silicon oxide (SiO₂), tantalum pentoxide (Ta₂O₅) or other tantalum oxide(s) (TaOₓ), hafnium oxide (HfO₂), carbon, metals, inorganic glasses, or the like.

Any example of the resin composition disclosed herein is deposited on the base support 16 and is patterned to form the reversibly swellable resin 18. The resin composition may be deposited on the base support 16 using any suitable application technique, which may be manual or automated. As examples, the deposition of the resin composition may be performed using vapor deposition techniques, coating techniques, grafting techniques, or the like. Some specific examples include chemical vapor deposition (CVD), spray coating (e.g., ultrasonic spray coating), spin coating, dunk or dip coating, doctor blade coating, puddle dispensing, aerosol printing, screen printing, microcontact printing, inkjet printing, or the like. In one example, spin coating is used.

After the resin composition is deposited, it may be softbaked to remove excess solvent and/or improve resin layer/substrate adhesion. When performed, the softbake may take place after the resin composition is deposited and before an imprinting apparatus (e.g., working stamp or other template) is positioned therein, and at a relatively low temperature, ranging from about 50° C. to about 150° C., for greater than 0 seconds to about 3 minutes. In an example, the softbake time ranges from about 30 seconds to about 2.5 minutes.

The deposited resin composition is then patterned, using any suitable patterning technique. In an example, nanoimprint lithography is used to pattern the resin composition. With nanoimprint lithography, an imprinting apparatus is pressed or rolled against the layer of the resin composition to create an imprint on the resin composition. The imprinting apparatus includes a template of the desired pattern that is to be transferred to the resin composition.

To generate the pattern shown in FIG. 2A, the imprinting apparatus includes protrusions, which are a negative replica of the depressions 20 that are to be formed in the resin composition.

Many different patterns for the depressions 20 may be envisaged, including regular, repeating, and non-regular patterns. In an example, the depressions 20 are disposed in a hexagonal grid for close packing and improved density. Other layouts may include, for example, rectangular layouts, triangular layouts, and so forth. In some examples, the layout or pattern can be an x-y format of depressions 20 that are in rows and columns. In some other examples, the layout or pattern can be a repeating arrangement of depressions 20 separated by interstitial regions 28.

The layout or pattern of the depressions 20 may be characterized with respect to the density of the depressions 20 (e.g., number of depressions 20) in a defined area. For example, the depressions 20 may be present at a density of approximately 2 million per mm². The density may be tuned to different densities including, for example, a density of about 100 per mm², about 1,000 per mm², about 0.1 million per mm², about 1 million per mm², about 2 million per mm², about 5 million per mm², about 10 million per mm², about 50 million per mm², or more, or less. It is to be further understood that the density of depressions 20 can be between one of the lower values and one of the upper values selected from the ranges above. As examples, a high density array may be characterized as having depressions 20 separated by less than about 100 nm, a medium density array may be characterized as having depressions 20 separated by about 400 nm to about 1 μm, and a low density array may be characterized as having depressions 20 separated by greater than about 1 μm. While example densities have been provided, it is to be understood that any suitable densities may be used. In some instances, it may be desirable for the spacing between depressions 20 to be even greater than the examples listed herein.

The layout or pattern of the depressions 20 may also or alternatively be characterized in terms of the average pitch, or the spacing from the center of one depression 20 to the center of an adjacent depression 20 (center-to-center spacing) or from the left edge of one depressions 20 to the right edge of an adjacent depressions 20 (edge-to-edge spacing). The pattern can be regular, such that the coefficient of variation around the average pitch is small, or the pattern can be non-regular in which case the coefficient of variation can be relatively large. In either case, the average pitch can be, for example, about 50 nm, about 0.1 μm, about 0.5 μm, about 1 μm, about 5 μm, about 10 μm, about 100 μm, or more or less. The average pitch for a particular pattern of depressions 20 can be between one of the lower values and one of the upper values selected from the ranges above. In an example, the depressions 20 have a pitch (center-to-center spacing) of about 1.5 μm. While example average pitch values have been provided, it is to be understood that other average pitch values may be used.

The size of each depression 20 may be characterized by its volume, opening area, depth, and/or diameter or length and width. As examples, the volume can range from about 1×10⁻³ μm³ to about 1×10⁴ μm³; the area for each depression opening can range from about 1×10⁻³ μm² to about 1×10 3 μm²; the depth of each depression 20 can range from about 0.1 μm to about 1×10³ μm; and the diameter or length and width of each depression 20 can range from about 50 nm to about 1×10 3 μm.

Referring back to the method for forming the reversibly swellable resin 18, the deposited resin composition may be then be cured with the imprinting apparatus in place, which forms the reversibly swellable resin 18 including the depressions 20 defined therein. Curing may be accomplished by exposing the resin composition (with the imprinting apparatus pressed therein) to incident light at a suitable energy dose (e.g., ranging from about 0.5 J to about 10 J) for 60 seconds or less. The incident light may be actinic radiation, such as ultraviolet (UV) radiation. In one example, the majority of the UV radiation emitted may have a wavelength of about 365 nm. In this example, curing may be performed with a 365 nm ultraviolet (UV) light source; and the deposited resin composition is exposed to UV light for a time ranging from about 3 seconds to about 30 seconds. In this example, the 365 nm UV light source may be a light emitting diode (LED) having a 330 mW/cm² power output (measured at the sample level).

In the examples disclosed herein, the light energy exposure initiates polymerization and crosslinking of the monomer(s) in the resin composition. The curing process may include a single UV exposure stage or a single heating event.

After curing, the imprinting apparatus may be removed. Upon release of the imprinting apparatus, topographic features, e.g., the depressions 20, are defined in the cured reversibly swellable resin 18.

The patterned structure 14 shown in FIG. 2A may be used as an open wafer, or may be bonded to a second patterned structure 14 or to a lid (not shown) to form a flow cell 10 having the architecture represented by FIG. 2A within each flow channel 12.

This example flow cell 10 is used with pre-clustered particles 22 (FIG. 2B), which will now be described.

Each of the pre-clustered particles 22 includes a particle core 24 and a plurality of amplicons 26 attached to the particle core 24. To generate pre-clustered particles 22, grafted particles are used in an off flow cell amplification technique. The grafted particles include the particle core 24 and a primer set attached to the core 24 (an example of the grafted particle 36 is shown in FIG. 4B).

In some examples, the particle core 24 is formed of a polymeric hydrogel. As examples, the polymeric hydrogel material may be poly(N-(5-azidoacetamidylpentyl)acrylamide-co-acrylamide (PAZAM) or another of the acrylamide copolymers disclosed herein, PEG-acrylate, PEG-diacrylate, PEG-amine, PEG-carboxylate, PEG-dithiol, PEG-epoxide, PEG-isocyanate, PEG-maleimide, crosslinked poly(methyl methacrylate) (PMMA), polyvinylpyrrolidone (PVPON), polyvinyl alcohol (PVA), polyethylene oxide-polypropylene oxide block copolymers (PEO-PPO), poly(hydroxyethyl methacrylate) (PHEMA), poly(N-isopropylacrylamide) (PNIPAAm), poly(lactic acid)-poly(ethylene glycol) block copolymers, poly(ethylene glycol)-poly(lactic-co-glycolic acid) block copolymers, poly(acrylic-co-vinylsulfonic acid), poly(acrylamide-co-vinylsulfonic acid), poly(L-aspartic acid), poly(aspartamide), adipic dihydrazide modified or aldehyde modified poly(L-glutamic acid), bisacrylamide, or hydrogels based on one or more of polylysine, starch, agar, agarose, heparin, alginate, alginate sulfate, dextran sulfate, hyaluronan, pectin, carrageenan, gelatin, chitosan, cellulose, and collagen, or combinations or mixtures thereof.

In some of the examples disclosed herein, the polymeric hydrogel is a copolymer including at least one acrylamide monomer unit, and is a linear polymeric hydrogel or branched polymeric hydrogel (e.g., a dendrimer). The linear or branched polymeric hydrogel may include a first recurring unit of formula (I):

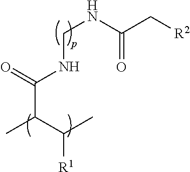

wherein:

R¹ is selected from the group consisting of —H, a halogen, an alkyl, an alkoxy, an alkenyl, an alkynyl, a cycloalkyl, an aryl, a heteroaryl, a heterocycle, and optionally substituted variants thereof;

R² is selected from the group consisting of an azido, an optionally substituted amino, an optionally substituted alkenyl, an optionally substituted alkyne, a halogen, an optionally substituted hydrazone, an optionally substituted hydrazine, a carboxyl, a hydroxy, an optionally substituted tetrazole, an optionally substituted tetrazine, nitrile oxide, nitrone, sulfate, and thiol; each (CH₂)ₚ can be optionally substituted; and p is an integer from 1 to 5; a second recurring unit of formula (II):

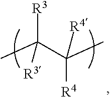

wherein: each of R³, R^{3′}, R⁴, R^{4′} is independently selected from the group consisting of —H, R⁵, —OR⁵, —C(O)OR⁵, —C(O)R⁵, —OC(O)R⁵, —C(O)NR⁶R⁷, and —NR⁶R⁷; R⁵ is selected from the group consisting of —H, —OH, an alkyl, a cycloalkyl, a hydroxyalkyl, an aryl, a heteroaryl, a heterocycle, and optionally substituted variants thereof; and each of R 6 and R 7 is independently selected from the group consisting of —H and an alkyl.

In an example of the polymeric hydrogel, R¹ is —H; R² is an azido; each of R^{3′}, R⁴, and R^{4′} is —H; R³ is —C(O)NR⁶R⁷, where each of R 6 and R 7 is —H; and p is 5. This polymeric hydrogel is poly(N-(5-azidoacetamidylpentyl)acrylamide-co-acrylamide, or PAZAM. In a variation of PAZAM, R¹ is —H; R² is an azido; each of R^{3′}, R⁴, and R^{4′} is —H; R³ is —C(O)NR⁶R⁷, where each of R 6 and R 7 is a C1-C6 alkyl (e.g., —CH₃); and p is 5.

In some examples, R² of some of the recurring units of formula (I) is replaced with tetramethylethylenediamine (TEMED). TEMED is a reaction promoter that may be introduced during copolymerization. As a result of a side reaction, TEMED replaces some of the azide (N₃) or other R² groups. While this reaction reduces the azide (or other R² examples) content of the copolymer chains, it also introduces a branching site. The branching sites may provide a location where the copolymer chains can branch to one other.

In other examples, a third recurring unit of formula (II) may be included, with the caveat that the second and third recurring units are different. For example, in the second recurring unit each of R^{3′}, R⁴, and R^{4′} is —H; R³ is —C(O)NR⁶R⁷, where each of R⁶ and R⁷ is —H, and in the third recurring unit, each of R^{3′}, R⁴, and R^{4′} is —H; R³ is —C(O)NR⁶R⁷, where each of R⁶ and R⁷ is a C1-C6 alkyl.

The number of first recurring units (formula (I)) may be an integer ranging from 2 to 50,000, and the number of second recurring units (formula (II)) may be an integer ranging from 2 to 100,000. When the third recurring unit is included, the number of units may be an integer in the range of 1 to 100,000. It is to be understood that the incorporation of the individual units may be statistical, random, or in block, and may depend upon the method used to synthesize the polymeric hydrogel.

In other examples of the polymeric hydrogel, the first recurring unit of formula (I) may be replaced with a heterocyclic azido group of formula (III):

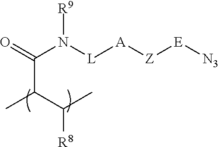

wherein R⁸ is H or a C1-C6 alkyl; R⁹ is H or a C1-C6 alkyl; L is a linker including a linear chain with 2 to 20 atoms selected from the group consisting of carbon, oxygen, and nitrogen and 10 optional substituents on the carbon and any nitrogen atoms in the chain; E is a linear chain including 1 to 4 atoms selected from the group consisting of carbon, oxygen and nitrogen, and optional substituents on the carbon and any nitrogen atoms in the chain; A is an N substituted amide with an H or a C1-C4 alkyl attached to the N; and Z is a nitrogen containing heterocycle. Examples of Z include 5 to 10 carbon-containing ring members present as a single cyclic structure or a fused structure. Some specific examples of Z include pyrrolidinyl, pyridinyl, or pyrimidinyl.

In one example of the polymeric hydrogel, formula (III) is the first recurring unit and formula (II) is the second recurring unit. In another example, formula (III) is the first recurring unit, one example of formula (II) is the second recurring unit, and a different example of formula (III) is the third recurring unit.

It is to be understood that other hydrogel materials may be used for the polymeric hydrogel of the particle core 24, as long as they are functionalized to graft oligonucleotide primers of a primer set thereto.

Other examples of other suitable polymeric hydrogels include functionalized polysilanes, such as norbornene silane, azido silane, alkyne functionalized silane, amine functionalized silane, maleimide silane, or any other polysilane having functional groups that can attach the oligonucleotide primers. Other examples of suitable polymeric hydrogels include those having a colloidal structure, such as agarose; or a polymer mesh structure, such as gelatin; or a cross-linked polymer structure, such as polyacrylamide polymers and copolymers, silane free acrylamide (SFA), or an azidolyzed version of SFA. Examples of suitable polyacrylamide polymers may be synthesized from acrylamide and an acrylic acid or an acrylic acid containing a vinyl group, or from monomers that form [2+2] photo-cycloaddition reactions. Still other examples of suitable polymeric hydrogel materials include mixed copolymers of acrylamides and acrylates. A variety of polymer architectures containing acrylic monomers (e.g., acrylamides, acrylates etc.) may be utilized in the examples disclosed herein, such as highly branched polymers, including dendrimers. For example, the monomers (e.g., acrylamide, etc.) may be incorporated, either randomly or in block, into the branches (arms) of a dendrimer.

An example of the dendrimeric polymeric hydrogel material includes a dendritic core with recurring units of formulas (II) and (III) in the arms extending from the core. The dendritic core may have anywhere from 3 arms to 30 arms.

The dendritic core may be any multi-functional component that enables a controlled polymerization mechanism, which leads to a defined arm length in the polymer structure and an at least substantially uniform arm length between polymer structures. In an example, the arms of the dendritic core are identical to each other.

The central molecule/compound of the dendritic core may be any multi-functional molecule, such as macrocycles (e.g., cyclodextrins, porphyrins, etc.), extended pi-systems (e.g., perylenes, fullerenes, etc.), metal-ligand complexes, polymeric cores, etc. Some specific examples of the central molecule/compound of the dendritic core include a phenyl group, benzoic acid, pentraerythritol, a phosphazene group, etc.

The dendritic core includes arms that extend from the central molecule/compound. Each arm may include a group that enables the monomers of formula (II) and (III) to be incorporated. In one example, a thiocarbonylthio group is included in each arm, and thus includes a reversible addition-fragmentation chain transfer agent (a RAFT agent). In another example, the dendritic core includes an atom transfer radical polymerization (ATRP) initiator in each arm. In still another example, the dendritic core includes a nitroxide (aminooxyl) mediated polymerization (NMP) initiator in each arm.

It is to be understood that functional groups in one or more of the recurring units of the polymeric hydrogel of the particle core 24 are capable of attaching the primers (not shown in FIG. 2B). These functional groups (e.g., R² in formula (I), NH₂, N₃, etc.) may be located in the side chains of the linear or branched polymeric hydrogel material. As noted, one example of the branched polymeric hydrogel is a dendrimer, and in an example, the primer-grafting functional groups are located in each of the arms of the dendrimer. These functional groups may be introduced as part of the monomer(s) used in copolymerization. To control the number of primer anchorage points, the monomer bearing the functional group may be increased or decreased. These functional groups may alternatively be introduced after copolymerization.

In other examples, the particle core 24 is a multi-layered particle including a core material coated with any example of the polymeric hydrogel disclosed herein. In these examples, the core material is generally rigid and is insoluble in an aqueous liquid. Examples of suitable core materials include magnetic materials (e.g., magnetic FeOₓ, silica coated FeOₓ), plastics (e.g., polytetrafluoroethylene (PTFE), some polyacrylics, polypropylene, polyethylene, polybutylene, polyurethanes, polystyrene and other styrene copolymers, nylon (i.e., polyamide), etc.), polycaprolactone (PCL), nitrocellulose, silica (SiO₂), silica-based materials (e.g., functionalized SiO₂), carbon, or metals. In these examples, the polymeric hydrogel coats the core material. The thickness of the polymeric hydrogel on the core material ranges from about 10 nm to about 200 nm.

As mentioned, the grafted particles used to generate the pre-clustered particles 22 include a primer set attached to the core particle 24. In this example, the primer set includes two different primers that are used in sequential paired end sequencing. In sequential paired end sequencing, the respective forward strands that are generated are sequenced and removed, and then the respective reverse strands are generated, sequenced, and removed.

As examples, the primer set may include P5 and P7 primers, P15 and P7 primers, or any combination of the PA primers, the PB primers, the PC primers, and the PD primers set forth herein. As examples, the primer set may include any two PA, PB, PC, and PD primers, or any combination of one PA primer and one PB, PC, or PD primer, or any combination of one PB primer and one PC or PD primer, or any combination of one PC primer and one PD primer. Examples of P5 and P7 primers are used on the surface of commercial flow cells sold by Illumina Inc. for sequencing, for example, on HISEQ™, HISEQX™, MISEQ™, MISEQDX™, MINISEQ™, NEXTSEQ™, NEXTSEQDX™, NOVASEQ™, ISEQ™, GENOME ANALYZER™, and other instrument platforms. The P5 and P7 primers have a universal sequence for seeding and/or amplification purposes. The P5 primer is:

P5: 5′ → 3′
(SEQ. ID. NO. 1)
AATGATACGGCGACCACCGAGAUCTACAC

The P7 primer may be any of the following:

P7 #1: 5′ → 3′
(SEQ. ID. NO. 2)
CAAGCAGAAGACGGCATACGAnAT
P7 #2: 5′ → 3′
(SEQ. ID. NO. 3)
CAAGCAGAAGACGGCATACnAGAT
P7 #3: 5′ → 3′
(SEQ. ID. NO. 4)
CAAGCAGAAGACGGCATACnAnAT

where “n” is 8-oxoguanine in each of the sequences.

The P15 primer is:

P15: 5′ → 3′
(SEQ. ID. NO. 5)
AATGATACGGCGACCACCGAGAnCTACAC

where “n” is allyl-T.

The other primers (PA-PD) mentioned above include:

PA 5′ → 3′
(SEQ. ID. NO. 6)
GCTGGCACGTCCGAACGCTTCGTTAATCCGTTGAG
cPA (PA′) 5′ → 3′
(SEQ. ID. NO. 7)
CTCAACGGATTAACGAAGCGTTCGGACGTGCCAGC
PB 5′ → 3′
(SEQ. ID. NO. 8)
CGTCGTCTGCCATGGCGCTTCGGTGGATATGAACT
cPB (PB′) 5′ → 3′
(SEQ. ID. NO. 9)
AGTTCATATCCACCGAAGCGCCATGGCAGACGACG
PC 5′ → 3′
(SEQ. ID. NO. 10)
ACGGCCGCTAATATCAACGCGTCGAATCCGCAACT
cPC (PC′) 5′ → 3′
(SEQ. ID. NO. 11)
AGTTGCGGATTCGACGCGTTGATATTAGCGGCCGT
PD 5′ → 3′
(SEQ. ID. NO. 12)
GCCGCGTTACGTTAGCCGGACTATTCGATGCAGC
cPD (PD′) 5′ → 3′
(SEQ. ID. NO. 13)
GCTGCATCGAATAGTCCGGCTAACGTAACGCGGC

While not shown in the example sequences for PA-PD, it is to be understood that any of these primers may include a cleavage site, such as uracil, 8-oxoguanine, allyl-T, diols, etc. at any point in the strand.

It is to be understood that the cleavage sites of the primers in the primer set of the grafted particles are orthogonal to each other (i.e., one cleavage site is not susceptible to the cleaving agent used for the other cleavage site), so that after amplification, forward or reverse strands can be cleaved, leaving the other of the reverse or forward strands for sequencing.

Each of the primers disclosed herein may also include a polyT sequence at the 5′ end of the primer sequence. In some examples, the polyT region includes from 2 T bases to 20 T bases. As specific examples, the polyT region may include 3, 4, 5, 6, 7, or 10 T bases.

The 5′ end of each primer may also include a linker. Any linker that includes a terminal alkyne group or another suitable terminal functional group that can attach to the surface functional groups of the polymeric hydrogel (of the particle core 24) may be used. In one example, the primers are 5′ terminated with hexynyl.

The immobilization of the primers may be by single point covalent attachment at the 5′ end of the primers. In this example, the attachment will depend, in part, on the functional groups of the polymeric hydrogel of the particle core 24. Examples of terminated primers that may be used include an alkyne terminated primer, a tetrazine terminated primer, an azido terminated primer, an amino terminated primer, an epoxy or glycidyl terminated primer, a thiophosphate terminated primer, a thiol terminated primer, an aldehyde terminated primer, a hydrazine terminated primer, a phosphoramidite terminated primer, and a triazolinedione terminated primer. In some specific examples, a succinimidyl (NHS) ester terminated primer may be reacted with an amine of the polymeric hydrogel, an aldehyde terminated primer may be reacted with a hydrazine of the polymeric hydrogel, or an alkyne terminated primer may be reacted with an azide of the polymeric hydrogel, or an azide terminated primer may be reacted with an alkyne or DBCO (dibenzocyclooctyne) or bicyclononyne (BCN) of the polymeric hydrogel, or an amino terminated primer may be reacted with an activated carboxylate group or NHS ester of the polymeric hydrogel, or a thiol terminated primer may be reacted with an alkylating reactant (e.g., iodoacetamine or maleimide) of the polymeric hydrogel, or a phosphoramidite terminated primer may be reacted with a thioether of the polymeric hydrogel. While several examples have been provided, it is to be understood that any functional group that can be attached to the primers and that can attach to a functional group of the polymeric hydrogel may be used.

The grafted particles disclosed herein are used in an off flow cell amplification process to generate amplicons 26 (i.e., template nucleic acid strands) that are attached to the particle core 24. This forms the pre-clustered particles 22, which can be used in first example flow cell 10 including the patterned structure 14 of FIG. 2A.

At the outset of amplicon 26 formation, library templates may be prepared from any nucleic acid sample (e.g., a DNA sample or an RNA sample). The DNA nucleic acid sample may be fragmented into single-stranded, similarly sized (e.g., <1000 bp) DNA fragments. The RNA nucleic acid sample may be used to synthesize complementary DNA (cDNA), and the cDNA may be fragmented into single-stranded, similarly sized (e.g., <1000 bp) cDNA fragments. During preparation, adapters may be added to the ends of any of the fragments. Through reduced cycle amplification, different motifs may be introduced in the adapters, such as sequencing primer binding sites, indices, and regions that are complementary to the primers on the grafted particles. In some examples, the fragments from a single nucleic acid sample have the same adapters added thereto. The final library templates include the DNA or cDNA fragment and adapters at both ends. The DNA or cDNA fragment represents the portion of the final library template that is to be sequenced.

A plurality of library templates may be introduced to a suspension containing a liquid carrier and the grafted particles. Examples of the liquid carrier include water or a buffer (e.g., a Tris-HCl buffer or 0.5× saline sodium citrate (SSC) buffer). Surfactants/dispersants, such as sodium dodecyl sulfate (SDS), (CTAB) may also be included.

Within the suspension, one or more library templates is/are hybridized, for example, to one of two types of primers of the primer set, which are immobilized to the grafted particles.

Amplification of the template nucleic acid strand(s) on the grafted particles may be initiated to form a cluster of the template strands (i.e., amplicons 26) across the particle surface. This generates the pre-clustered particles 22 (FIG. 2B). In one example, amplification involves cluster generation. In one example of cluster generation, the library templates are copied from the hybridized primers by 3′ extension using a high-fidelity DNA polymerase. The original library templates are denatured, leaving the copies immobilized all around the grafted particles. Isothermal bridge amplification or some other form of amplification may be used to amplify the immobilized copies. For example, the copied templates loop over to hybridize to an adjacent, complementary primer, and a polymerase copies the copied templates to form double stranded bridges, which are denatured to form two single stranded strands. These two strands loop over and hybridize to adjacent, complementary primers and are extended again to form two new double stranded loops. The process is repeated on each template copy by cycles of isothermal denaturation and amplification to create dense clonal clusters on the grafted particles. Each cluster of double stranded bridges is denatured. In an example, the reverse strands are removed by specific base cleavage, leaving forward template strands. Clustering results in the formation of the pre-clustered particles 22, which includes several template strands/amplicons 26 immobilized on the particle core 24. This example of clustering is referred to as bridge amplification, and is one example of the amplification that may be performed. It is to be understood that other amplification techniques may be used, e.g., exclusion amplification.

The pre-clustered particles 22 may be washed to remove unreacted library templates, etc. and suspended in a fresh liquid carrier to form a pre-clustered particle solution. Any of the examples of the liquid carrier may be used.

An example method involves introducing the pre-clustered particle solution into the flow cell 10 including the patterned structure 14; allowing the pre-clustered particle solution to incubate in the flow cell 10, whereby a pre-clustered particle 22 settles into the depression 20; exposing the reversibly swellable resin 18 to a stimulus, thereby causing the first opening dimension D₁ to reduce to a second opening dimension D₂ and trapping the pre-clustered particle 22 in the depression 20; washing out non-trapped pre-clustered particles 22; and maintaining the stimulus exposure at least until an analysis involving the trapped pre-clustered particle 22 is performed.

The pre-clustered particles 22 may be used in sequencing on the flow cell 10 that includes the patterned structure 14. After off-board amplification and cluster generation, the pre-clustered particle solution is introduced into the flow cell 10. The solution may be allowed to incubate for a predetermined time in the flow cell 10 to allow the pre-clustered particles 22 to respectively settle into the depressions 20. In an example, the incubation period may range from about 0.1 seconds to about 30 minutes.

During or after the incubation period, the reversibly swellable resin 18 may be exposed to a stimulus which causes the resin to swell, thus reducing the first opening dimension Di to the second opening dimension D₂ and trapping respective pre-clustered particles 22 in at least some of the depressions 20. The stimulus is selected from the group consisting of a predetermined liquid or a liquid having a predetermined pH. Examples of the predetermined liquid for swelling the resin 18 include water, alcohols (e.g., methanol, ethanol, propanol, ethylene glycol, propylene glycol, etc.), or ionic liquids. The predetermined pH that can act as a stimulus for swelling the resin 18 may range from about 4 to about 12. The liquid having the desired pH may be a buffer, such as KPi, any phosphate buffer, or any other buffer having a pH suitable for triggering the response of the reversibly swellable resin. A salt (NaCl, KCl, etc.) may be added to further increase the ionic strength of the buffer.

After incubation, a wash cycle may be performed to remove any non-trapped pre-clustered particles 22 and the liquid carrier of the suspension.

Sequencing primers may then be introduced to the flow cell 10. The sequencing primers hybridize to a complementary portion of the sequence of the amplicons 26 that are attached to the pre-clustered particles 22 (which are now trapped in the depressions 20). These sequencing primers render the amplicons 26 ready for sequencing.

An incorporation mix including labelled nucleotides may then be introduced into the flow cell 10, e.g., via an input port. In addition to the labelled nucleotides, the incorporation mix may include water, a buffer, and polymerases capable of nucleotide incorporation. When the incorporation mix is introduced into the flow cell 10, the mix enters the flow channel 12, and contacts the trapped and sequence ready pre-clustered particles 22.

The incorporation mix is allowed to incubate in the flow cell 20, and labelled nucleotides (including optical labels) are incorporated by respective polymerases into the nascent strands along the amplicons 26 on each of the pre-clustered particles 22. During incorporation, one of the labelled nucleotides is incorporated, by a respective polymerase, into one nascent strand that extends one sequencing primer and that is complementary to one of the amplicons 26. Incorporation is performed in a template strand dependent fashion, and thus detection of the order and type of labelled nucleotides added to the nascent strand can be used to determine the sequence of the amplicon 26. Incorporation occurs in at least some of the amplicons 26 across the pre-clustered particles 22 during a single sequencing cycle.

The incorporated labelled nucleotides may include a reversible termination property due to the presence of a 3′ OH blocking group, which terminates further sequencing primer extension once the labelled nucleotide has been added. After a desired time for incubation and incorporation, the incorporation mix, including non-incorporated labelled nucleotides, may be removed from the flow cell 10 during a wash cycle. The wash cycle may involve a flow-through technique, where a washing solution (e.g., buffer) is directed into, through, and then out of flow channel 12, e.g., by a pump or other suitable mechanism.

Without further incorporation taking place, the most recently incorporated labelled nucleotides can be detected through an imaging event. During the imaging event, an illumination system may provide an excitation light to the flow cell 10. The optical labels of the incorporated labelled nucleotides emit optical signals in response to the excitation light.

After imaging is performed, a cleavage mix may then be introduced into the flow cell 10. In an example, the cleavage mix is capable of i) removing the 3′ OH blocking group from the incorporated nucleotides, and ii) cleaving the optical label from the incorporated nucleotide. Examples of 3′ OH blocking groups and suitable de-blocking agents/components in the cleavage mix may include: ester moieties that can be removed by base hydrolysis; allyl-moieties that can be removed with NaI, chlorotrimethylsilane and Na₂S₂O₃ or with Hg(II) in acetone/water; azidomethyl which can be cleaved with phosphines, such as tris(2-carboxyethyl)phosphine (TCEP) or tri(hydroxypropyl)phosphine (THP); acetals, such as tert-butoxy-ethoxy which can be cleaved with acidic conditions; MOM (—CH₂OCH₃) moieties that can be cleaved with LiBF₄ and CH₃CN/H₂O; 2,4-dinitrobenzene sulfenyl which can be cleaved with nucleophiles such as thiophenol and thiosulfate; tetrahydrofuranyl ether which can be cleaved with Ag(I) or Hg(II); and 3′ phosphate which can be cleaved by phosphatase enzymes (e.g., polynucleotide kinase). Examples of suitable optical label cleaving agents/components in the cleavage mix may include: sodium periodate, which can cleave a vicinal diol; phosphines, such as tris(2-carboxyethyl)phosphine (TCEP) or tris(hydroxypropyl)phosphine (THP), which can cleave azidomethyl linkages;

palladium and THP, which can cleave an allyl; bases, which can cleave ester moieties; or any other suitable cleaving agent.

Additional sequencing cycles may then be performed until the amplicons 26 are sequenced.

Throughout the analysis (e.g., all of the sequencing cycles), the stimulus is applied so that the reversible swellable resin 18 remains in the swelled state so that the opening dimension remains in the narrower or smaller position. As one example, when water is the stimulus, the wash fluid, the sequencing primer fluid, the incorporation mix, and the cleavage mix may each include water so that the reversibly swellable resin 18 is consistently exposed to the aqueous stimulus. As another example, when pH is the stimulus, the pH of the wash fluid, the pH of the sequencing primer fluid, the pH of the incorporation mix, and the pH of the cleavage mix may each be at the proper pH so that the reversibly swellable resin 18 is consistently exposed to the pH stimulus.

After the analysis, the stimulus may be removed or an orthogonal stimulus may be applied to de-swell and thus contract the reversibly swellable resin 18. The removal of the stimulus or the application of the orthogonal stimulus causes the reversibly swellable resin 18 to revert back to the non-swelled stated, where the depressions 20 have the first (larger) opening dimension Di. In other words, removing the stimulus or applying an orthogonal stimulus after the analysis causes the reversibly swellable resin 18 to contract so that the second opening dimension D₂ is increased to the first opening dimension Di. This frees the now-sequenced particles, enabling them to be washed from the flow cell 10. This example of the flow cell may be used again with fresh pre-clustered particles 22.

In another specific example of the method, the stimulus is the liquid having the predetermined pH; exposing the reversibly swellable resin 18 to the stimulus takes place when the pre-clustered particle solution is introduced into the flow cell 10; and maintaining the stimulus exposure involves introducing at least one aqueous reagent having the predetermined pH during the analysis.

### Second Example Flow Cell and Method

The patterned structure 14′ in the second example of the flow cell 10 includes a base support 16; the reversibly swellable resin 18 positioned over the base support 16; a depression 20 defined in the reversibly swellable resin 18, the depression 20 having a first opening dimension Di when the reversibly swellable resin 18 is in a non-swelled stated (FIG. 3A) and having a second opening dimension D2, that is smaller than the first opening dimension D₁, when the reversibly swellable resin 18 is in a swelled stated (FIG. 3B); a polymeric hydrogel 30 attached to the reversibly swellable resin 18 in each of the depressions 20; and a single primer set (including primers 32A, 32B) grafted to the polymeric hydrogel 30.

In this patterned structure 14′, the base support 16 may be any of the examples set forth herein.

Any example of the resin composition disclosed herein that forms a reversibly swellable resin 18 that is swellable upon exposure to water, alcohols, ionic liquids, or another liquid at a predetermined pH may be used in this example. The resin composition is deposited on the base support 16 and is patterned to form the reversibly swellable resin 18 having the depressions 20 defined therein. The formation of the cured and patterned reversibly swellable resin 18 may be accomplished as described in reference to FIG. 2A and FIG. 2B.

In this example of the patterned structure 14′, any example of the polymeric hydrogel 30 may be deposited on the reversibly swellable resin 18, including in the depressions 20 and on the interstitial regions 28. It is to be understood that any example of the polymeric hydrogel described herein for the pre-clustered particle 22 may be used in the patterned structure 14′.

To introduce the polymeric hydrogel 30 into the depressions 20, a mixture of the polymeric hydrogel 30 may be generated and then applied to the reversibly swellable resin 18. In one example, any example of the polymeric hydrogel 30 disclosed herein may be present in a mixture (e.g., with water or with ethanol and water). The mixture may then be applied to the surface of the reversibly swellable resin 18 using spin coating, or dipping or dip coating, or flow of the material under positive or negative pressure, or another suitable technique. These types of techniques blanketly deposit the polymeric hydrogel 30 in the depressions 20 and on the interstitial regions 28. Other selective deposition techniques (e.g., involving a mask, controlled printing techniques, etc.) may be used to specifically deposit the polymeric hydrogel 30 in the depressions 20 and not on the interstitial regions 28.

In some examples, the reversibly swellable resin 18 may include functional groups that can covalently or non-covalently attach to the polymeric hydrogel 30. As examples, an azide of the polymeric hydrogel 30 may be reacted with an alkyne or DBCO (dibenzocyclooctyne) or bicyclononyne (BCN) of the reversibly swellable resin 18, and an amino of the reversibly swellable resin 18 may be reacted with an activated carboxylate group or an N-hydroxysuccinimide (NHS) ester of the polymeric hydrogel 30. An aldehyde of the polymeric hydrogel 30 may be reacted with an aldehyde of the reversibly swellable resin 18.

Alternatively, the surface of the reversibly swellable resin 18 (including in the depressions 20) may be activated, and then the mixture (including the polymeric hydrogel 30) may be applied thereto. In one example, a silane or silane derivative (e.g., norbornene silane) may be deposited on the surface of the reversibly swellable resin 18 using vapor deposition, spin coating, or other deposition methods. In another example, the surface of the reversibly swellable resin 18 may be exposed to plasma ashing to generate surface-activating agent(s) (e.g., —OH groups) that can adhere to the polymeric hydrogel 30. In still other examples, ashing followed by silanization is used to activate the reversibly swellable resin 18.

Depending upon the chemistry of the polymeric hydrogel 30, the applied mixture may be exposed to a curing process. In an example, curing may take place at a temperature ranging from room temperature (e.g., about 25° C.) to about 95° C. for a time ranging from about 1 millisecond to about several days.

When a blanket deposition technique is used, polishing may then be performed in order to remove the polymeric hydrogel 30 from the interstitial regions 28, while leaving the polymeric hydrogel 30 on the surface in the depressions 20 at least substantially intact.

The polishing process may be performed with a chemical slurry (including, e.g., an abrasive, a buffer, a chelating agent, a surfactant, and/or a dispersant) which can remove the polymeric hydrogel 30 from the interstitial regions 28 without deleteriously affecting the underlying reversibly swellable resin 18 at those regions 28. Alternatively, polishing may be performed with a solution that does not include the abrasive particles.

The chemical slurry may be used in a chemical mechanical polishing system to polish the surface of the interstitial regions 28. The polishing head(s)/pad(s) or other polishing tool(s) is/are capable of polishing the polymeric hydrogel 30 that may be present over the interstitial regions 28 while leaving the polymeric hydrogel 30 in the depression(s) 20 at least substantially intact. As an example, the polishing head may be a Strasbaugh ViPRR II polishing head.

Cleaning and drying processes may be performed after polishing. The cleaning process may utilize a water bath and sonication. The water bath may be maintained at a relatively low temperature ranging from about 22° C. to about 30° C. The drying process may involve spin drying, or drying via another suitable technique.

In this example of the patterned structure 14′, a primer set is grafted to the polymeric hydrogel 30. The primer set includes two different primers 32A, 32B that are used in sequential paired end sequencing. The primers 32A, 32B may be any of the examples described herein in reference to FIG. 2A and FIG. 2B, such as the P5 and P7 primers, the P15 and P7 primers, or any combination of the PA primers, the PB primers, the PC primers, and the PD primers.

The primers 32A, 32B may be grafted to the polymeric hydrogel 30 before or after the polymeric hydrogel 30 is introduced into depressions 20. Grafting may be accomplished by flow through deposition (e.g., using a temporarily or permanently bound lid), dunk coating, spray coating, puddle dispensing, or by another suitable method. Each of these example techniques may utilize a primer solution or mixture, which may include the primer(s) 32A, 32B, water, a buffer, and a catalyst. With any of the grafting methods, the primers 32A, 32B attach to the reactive groups of the polymeric hydrogel 30 and do not react with the interstitial regions 28.

The patterned structure 14′ shown in FIG. 3A may be used as an open wafer, or may be bonded to a second patterned structure 14′ or to a lid (not shown) to form a flow cell having the architecture represented by FIG. 3A within each flow channel 12.

In this example flow cell 10, amplicons (not shown in FIG. 3A or FIG. 3B) are generated within the depressions 20, and then the analysis (e.g., sequencing) is performed. In this example, the reversible swellable resin 18 is used to minimize or prevent the occurrence of multiple seeding events taking place in a single depression 20, thus reducing or eliminating polyclonality (i.e., two or more different template strands being seeded and amplified within a single depression 20).

An example method involves introducing a predetermined liquid into the flow cell 10 including the patterned structure 14′; allowing the predetermined liquid to incubate in the flow cell 10, whereby the reversibly swellable resin 18 swells so that the first opening dimension D₁ is reduced to a second opening dimension D₂; and introducing a template strand solution into the flow cell 10 while the reversibly swellable resin 18 is swelled.

At the outset of this method, a predetermined liquid is introduced into the flow cell 10 and is allowed to incubate in the flow cell 10 to induce swelling of the reversibly swellable resin 18. An example of the predetermined liquid is an aqueous solution, which includes water, alone or as part of a buffer (e.g., a Tris-HCl buffer or 0.5× saline sodium citrate (SSC) buffer). Other examples of the predetermined liquid include an alcohol or an ionic liquid. Still another example is the liquid having a pH ranging from about 4 to about 12. The predetermined liquid functions as the stimulus for the reversibly swellable resin 18 to swell, and causes the first opening dimension D₁ to reduce to the second opening dimension D₂. In an example, the predetermined liquid may be allowed to incubate for a time period ranging from about 5 seconds to about 5 minutes before the template strand solution is introduced into the flow cell.

The template strand solution includes library templates dispersed in a liquid carrier. Any example of the liquid carrier set forth herein may be used in the template strand solution. The template strands (library templates) present in the template strand solution may be prepared from any nucleic acid sample (e.g., a DNA sample or an RNA sample) as described herein.

The template strand solution is introduced into the flow cell. As depicted in FIG. 3B, a template strand hybridizes to one of the two types of primers 32A, 32B that are immobilized in the depression 20. The seeded template strands are shown at reference numerals 33, 33′ in FIG. 3B. The narrower opening of the depressions 20 and the rate of amplification help to reduce the occurrence of more than one template strand 33, 33′ hybridizing (i.e., seeding) within a single depression 20.

Amplification of the seeded template nucleic acid strand(s) 33, 33′ in the depressions 20 may be initiated to form respective clusters of the seeded template strands 33, 33′ across the depression 20. In one example, amplification involves cluster generation. In one example of cluster generation, the seeded library templates 33, 33′ are copied from the hybridized primers by 3′ extension using a high-fidelity DNA polymerase. The original seeded library templates 33, 33′ are denatured, leaving the copies immobilized in the depressions 20. Isothermal bridge amplification or some other form of amplification may be used to amplify the immobilized copies. For example, the copied templates loop over to hybridize to an adjacent, complementary primer, and a polymerase copies the copied templates to form double stranded bridges, which are denatured to form two single stranded strands. These two strands loop over and hybridize to adjacent, complementary primers and are extended again to form two new double stranded loops. The process is repeated on each template copy by cycles of isothermal denaturation and amplification to create dense clonal clusters on the functionalized particles. Each cluster of double stranded bridges is denatured. In an example, the reverse strands are removed by specific base cleavage, leaving forward template strands. Clustering primarily results in the formation of clusters of a specific template strand 33, 33′, which includes several template strand copies/amplicons immobilized in the respective depressions 20. This example of clustering is referred to as bridge amplification, and is one example of the amplification that may be performed. It is to be understood that other amplification techniques may be used, e.g., exclusion amplification.

The flow cell 10 may be washed to remove unreacted library templates. The sequencing analysis may then be performed as described in reference to FIG. 2B.

Throughout this method, it is to be understood that the template strand solution, the wash fluid, and the sequencing reagents (e.g., sequencing primer fluid, incorporation mix, and cleavage mix) maintain the aqueous condition within the flow cell 10, and thus keep the reversibly swellable resin 18 in the swelled state throughout the analysis.

After the analysis, the aqueous fluids and thus the stimulus may be removed to de-swell and thus contract the reversibly swellable resin 18.

While the polymeric hydrogel 30 is shown in the example of FIG. 3A and FIG. 3B, it is to be understood that the patterned structure 14′ may not include the polymeric hydrogel 30 if the reversibly swellable resin 18 includes surface functional groups that can directly attach to a 5′ end of the primers 32A, 32B. In this particular example, the interstitial regions 28 may be masked during primer grafting so that they remain free of the primers 32A, 32B. This example may enable smaller depressions and brighter signals.

### Third Example Flow Cell and Method

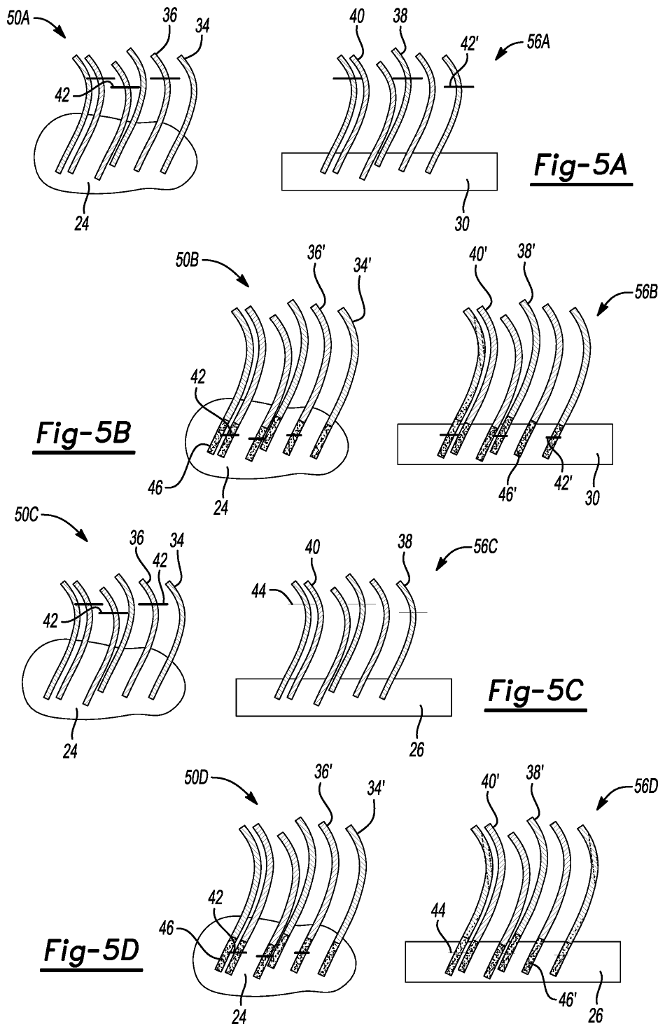

FIG. 4A through FIG. 4D illustrate an example of a method for making another example of the patterned structure 14″ shown in FIG. 4D. This patterned structure 14″ may be used in the third example of the flow cell 10, which includes a base support 16; the reversibly swellable resin 18 positioned over the base support 16; a multi-depth depression 20′ defined in the reversibly swellable resin 18, where the multi-depth depression 20′ includes a deep portion 52 and a shallow portion 54 adjacent to the deep portion 52, and where the deep portion 52 has the first opening dimension D₁when the reversibly swellable resin 18 is in a non-swelled stated (FIG. 4A) and has the second opening dimension D₂, that is smaller than the first opening dimension D₁, when the reversibly swellable resin 18 is in a swelled stated (FIG. 4B); a grafted particle 50 confined within the deep portion 52, the grafted particle 50 having a first primer set (including primers 34, 36 or 34′, 36′ as shown in FIG. 5A through FIG. 5D) grafted to a core particle 24; and a pre-grafted polymer 56 positioned on a surface 58 at the shallow portion 54, the pre-grafted polymer 56 having a second primer set (including primers 38, 40 or 38′, 40′ as shown in FIG. 5A through FIG. 5D) that is orthogonal to the first primer set and that is grafted to a polymeric hydrogel 30.

In this patterned structure 14″, the base support 16 may be any of the examples set forth herein.

Any example of the resin composition disclosed herein that forms a reversibly swellable resin 18 that is swellable upon exposure to water may be used in this example. The resin composition is deposited on the base support 16 and is patterned to form the reversibly swellable resin 18 having multi-depth depressions 20′ defined therein. The formation of the cured and patterned reversibly swellable resin 18 may be accomplished as described in reference to FIG. 2A and FIG. 2B, except that the imprinting apparatus has the negative replica of the multi-depth depressions 20′.

For each multi-depth depression 20′, it is to be understood that the depth of the deep portion 52 and the depth of the shallow portion 54 are each within the ranges provided herein for the depth of the depressions 20, with the caveat that the depth of the deep portion 52 is greater than the depth of the shallow portion 54. It is to be understood that the height of the internal wall 60 will vary depending upon the different depths of the deep and shallow portions 52, 54.

This example flow cell 10 is used with grafted particles 50 and a pre-grafted polymer 56, examples of which will now be described in reference to FIG. 5A through FIG. 5D. The grafted particle 50 includes a first primer set and the pre-grafted polymer 56 includes a second primer set, and the first and second primer sets enable simultaneous paired-end sequencing. As will be described in more detail below, the primer sets may be controlled so that the cleaving (linearization) chemistry of the primers of the grafted particle 50 is orthogonal to the primers of the pre-grafted polymer 56. In these examples, orthogonal cleaving chemistry may be realized through identical cleavage sites that are attached to different primers in the different sets, or through different cleavage sites that are attached to different primers in the different sets. This enables a cluster of forward strands to be generated, for example, on the particle 50 and a cluster of reverse strands to be generated on the polymer 56. The particle 50 and the polymer 56 are different portions of the multi-depth depression 20′, and thus the generated forward and reverse strands are spatially separate, which separates the fluorescence signals from both reads while allowing for simultaneous base calling of each read.

The primer set attached to the grafted particles 50A, 50B, 50C, and 50D includes an un-cleavable first primer 34 or 34′ and a cleavable second primer 36 or 36′; and the primer set attached to the pre-grafted polymer 56A, 56B, 56C, and 56D includes a cleavable first primer 38 or 38′ and an un-cleavable second primer 40 or 40′.

The un-cleavable first primer 34 or 34′ and the cleavable second primer 36 or 36′ are oligonucleotide pairs, e.g., where the un-cleavable first primer 34 or 34′ is a forward amplification primer and the cleavable second primer 36 or 36′ is a reverse amplification primer or where the cleavable second primer 36 or 36′ is the forward amplification primer and the un-cleavable first primer 34 or 34′ is the reverse amplification primer. In each example of the primer set attached to the grafted particles 50A, 50B, 50C, and 50D, the cleavable second primer 36 or 36′ includes a cleavage site 42, while the un-cleavable first primer 34 or 34′ does not include a cleavage site 42.

The cleavable first primer 38 or 38′ and the un-cleavable second primer 40 or 40′ are also oligonucleotide pairs, e.g., where the cleavable first primer 38 or 38′ is a forward amplification primer and the un-cleavable second primer 40 or 40′ is a reverse amplification primer or where the un-cleavable second primer 40 or 40′ is the forward amplification primer and the cleavable first primer 38 or 38′ is the reverse amplification primer. In each example of the primer set attached to the pre-grafted polymer 56A, 56B, 56C, and 56D, the cleavable first primer 38 or 38′ includes a cleavage site 42′ or 44, while the un-cleavable second primer 40 or 40′ does not include a cleavage site 42′ or 44.

It is to be understood that the un-cleavable first primer 34 or 34′ of the primer set attached to the grafted particles 50A, 50B, 50C, and 50D and the cleavable first primer 38 or 38′ of the primer set attached to the pre-grafted polymer 56A, 56B, 56C, and 56D have the same nucleotide sequence (e.g., both are forward amplification primers), except that the cleavable first primer 38 or 38′ includes the cleavage site 42′ or 44 integrated into the nucleotide sequence or into a linker 46′ attached to the nucleotide sequence. Similarly, the cleavable second primer 36 or 36′ of the primer set attached to the grafted particles 50A, 50B, 50C, and 50D and the un-cleavable second primer 40 or 40′ of the primer set attached to the pre-grafted polymer 56A, 56B, 56C, and 56D have the same nucleotide sequence (e.g., both are reverse amplification primers), except that the cleavable second primer 36 or 36′ includes the cleavage site 42 integrated into the nucleotide sequence or into a linker 46 attached to the nucleotide sequence.

It is to be understood that when the first primers 34 and 38 or 34′ and 38′ are forward amplification primers, the second primers 36 and 40 or 36′ and 40′ are reverse primers, and vice versa.

The un-cleavable primers 34, 40 or 34′, 40′ may be any primers with a universal sequence for capture and/or amplification purposes, such as the P5 or P15 and P7 primers, or any combination of the PA, PB, PC, and PD primers (e.g., PA and PB or PA and PD, etc.), with the caveat that the uracil, 8-oxoguanine, or other cleavage site is not included in the sequence. These primers 34, 40 or 34′, 40′ are un-cleavable primers 34, 40 or 34′, 40′ because they do not include a cleavage site 42, 42′, 44.

Examples of cleavable primers 36, 38 or 36′, 38′ include the P5 or P15 and P7 primers or other universal sequence primers (e.g., the PA, PB, PC, PD primers) with the respective cleavage sites 42, 42′, 44 incorporated into the respective nucleic acid sequences (e.g., FIG. 5A and FIG. 53C), or into a linker 46′, 46 that attaches the cleavable primers 36, 38 or 36′, 38′ to the core particle 24 or polymer 30 (FIG. 5B and FIG. 5D). Examples of suitable cleavage sites 42, 42′, 44 include enzymatically cleavable nucleobases or chemically cleavable nucleobases, modified nucleobases, or linkers (e.g., between nucleobases), as described herein. Some specific examples of the cleavage sites 42, 42′, 44 include uracil, 8-oxoguanine, allyl-T. The cleavage sites 42, 42′, 44 may be incorporated at any point in the strand.

The primer set including the primers 34, 36 or 34′, 36′ is attached to an example of the particle core 24 described herein, and the primer set including the primers 38, 40 or 38′, 40′ is attached to an example of the polymeric hydrogel 30 disclosed herein. In this example, the particle core 24 includes functional groups that can attach the 5′ end of the primers 34, 36 or 34′, 36′, and the polymeric hydrogel 30 includes functional groups that can attach the 5′ end of the primers 38, 40 or 38′, 40′.

FIG. 5A through FIG. 5D depict different configurations of the primer sets respectively attached to the particle core 24 and the polymeric hydrogel 30. More specifically, FIG. 5A through FIG. 5D depict different configurations of the primers 34, 36 or 34′, 36′ and 38, 40 or 38′, 40′ that may be used.

In the example shown in FIG. 5A, the primers 34, 36 and 38, 40 are respectively and directly attached to the particle core 24 and the polymeric hydrogel 30, for example, without a linker 46, 46′. The particle core 24 has surface functional groups that can immobilize the terminal groups at the 5′ end of the primers 34, 36. Similarly, the polymeric hydrogel 30 has surface functional groups that can immobilize the terminal groups at the 5′ end of the primers 38, 40. Because the respective primers 34, 36 and 38, 40 are pre-grafted (i.e., grafted before the particle 50 or polymer 56 is incorporated into the flow cell 10), the immobilization chemistry between the particle core 24 and the primers 34, 36 and the immobilization chemistry between the polymeric hydrogel 30 and the primers 38, 40 may be the same or different.

Also, in the example shown in FIG. 5A, the cleavage site 42, 42′ of each of the cleavable primers 36, 38 is incorporated into the sequence of the primer. In this example, the same type of cleavage site 42, 42′ is used in the cleavable primers 36, 38 of the respective primer sets. As an example, the cleavage sites 42, 42′ are uracil bases, and the cleavable primers 36, 38 are P5U and P7U (where uracil is incorporated into any of the P7 sequences set forth herein in place of the 8-oxoguanine). The uracil bases or other cleavage sites may also be incorporated into any of the PA, PB, PC, and PD primers to generate the cleavable primers 36, 38. In this example, the un-cleavable primer 34 of the oligonucleotide pair 34, 36 may be P7 (without the cleavage site, e.g., SEQ. ID. NOS. 2-4 without 8-oxoguanine), and the un-cleavable primer 40 of the oligonucleotide pair 38, 40 may be P5 (without the cleavage site, e.g., SEQ. ID. NO. 1 without uracil). Thus, in this example, the primer set of the grafted particle 50A includes P7, P5U and the primer set of the pre-grafted polymer 56A includes P5, P7U. The primer sets of the grafted particle 50A and the pre-grafted polymer 56A have opposite linearization chemistries, which, after amplification, cluster generation, and linearization, allows forward template strands to be formed on the particle 50A and reverse strands to be formed on the polymer 56A.

In the example shown in FIG. 5B, the primers 34′, 36′ and 38′, 40′ are respectively attached to the particle core 24 and the polymeric hydrogel 30, for example, through a linker 46, 46′. The particle core 24 and the polymeric hydrogel 30 include respective functional groups, and the terminal ends of the respective linkers 46, 46′ are capable of covalently attaching to the respective functional groups. As such, the particle core 24 includes surface functional groups that can immobilize the linker 46 at the 5′ end of the primers 34′, 36′. Similarly, the polymeric hydrogel 30 includes surface functional groups that can immobilize the linker 46′ at the 5′ end of the primers 38′, 40′. Because the respective primers 34, 36 and 38, 40 are pre-grafted, the immobilization chemistry between the particle core 24 and the linker 46 and the immobilization chemistry between the polymeric hydrogel 30 and the linker 46′ may be the same or different.

Examples of suitable linkers 46, 46′ may include nucleic acid linkers (e.g., 10 nucleotides or less) or non-nucleic acid linkers, such as a polyethylene glycol chain, an alkyl group or a carbon chain, an aliphatic linker with vicinal diols, a peptide linker, etc. An example of a nucleic acid linker is a polyT spacer, although other nucleotides can also be used. In one example, the spacer is a 6T to 10T spacer. The following are some examples of nucleotides including non-nucleic acid linkers with terminal alkyne groups (where B is the nucleobase and “oligo” is the primer):

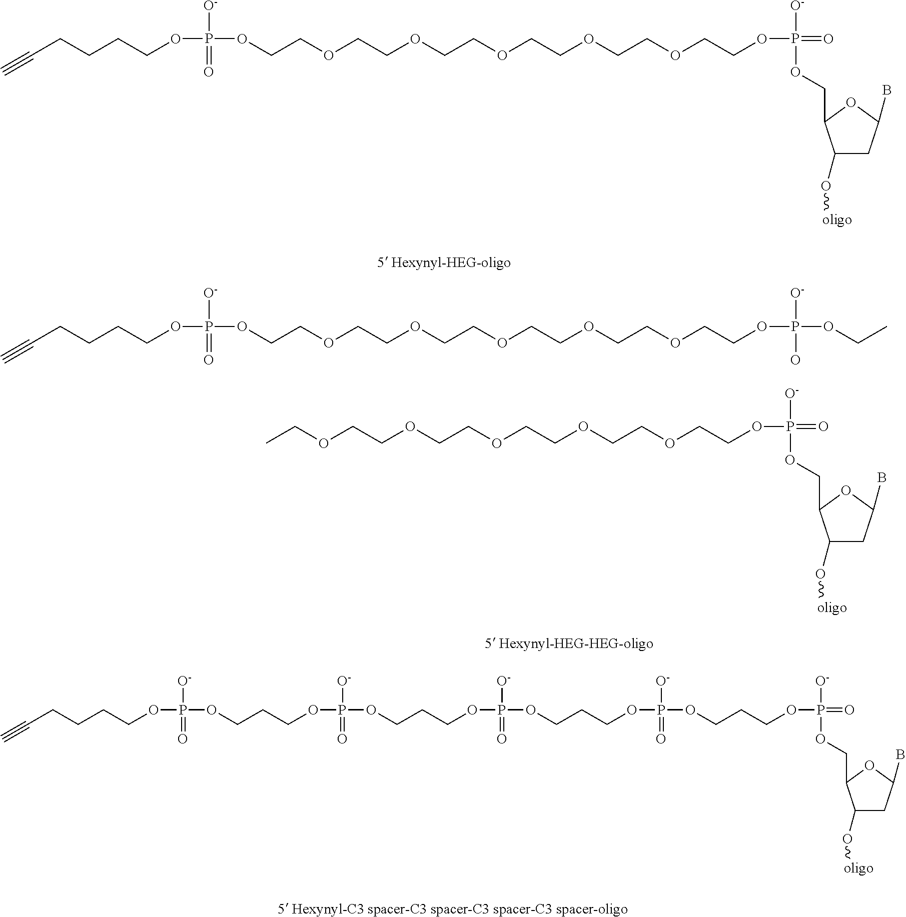

In the example shown in FIG. 5B, the primers 34′, 38′ have the same sequence (e.g., P5 without the uracil base). The primer 34′ is un-cleavable (i.e., does not include any cleavage site), whereas the primer 38′ includes the cleavage site 42′ incorporated into the linker 46′. Also in this example, the primers 36′, 40′ have the same sequence (e.g., P7 without the 8-oxoguanine). The primer 40′ is un-cleavable (i.e., does not include any cleavage site), and the primer 36′ includes the cleavage site 42 incorporated into the linker 46. The same type of cleavage site 42, 42′ is used in the linker 46, 46′ of each of the cleavable primers 36′, 38′. As an example, the cleavage sites 42, 42′ may be uracil bases that are incorporated into nucleic acid linkers 46, 46′. The primer sets of the particle 50B and the polymer 56B have opposite linearization chemistries, which, after amplification, cluster generation, and linearization, allows forward template strands to be formed on the particle 50B and reverse strands to be formed on the polymer 56B.

The example shown in FIG. 5C is similar to the example shown in FIG. 5A, except that different types of cleavage sites 42, 44 are used in the cleavable primers 36, 38 of the particle 50C and the polymer 56C. As examples, two different enzymatic cleavage sites may be used, two different chemical cleavage sites may be used, or one enzymatic cleavage site and one chemical cleavage site may be used. Examples of different cleavage sites 42, 44 that may be used in the respective cleavable primers 36, 38 include any combination of the following: vicinal diol, uracil, allyl ether, disulfide, restriction enzyme site, and 8-oxoguanine.

The example shown in FIG. 5D is similar to the example shown in FIG. 5B, except that different types of cleavage sites 42, 44 are used in the linkers 46, 46′ attached to the cleavable primers 36′, 38′ of the particle 50C and the polymer 56C. Examples of different cleavage sites 42, 44 that may be used in the respective linkers 46, 46′ attached to the cleavable primers 36′, 38′ include any combination of the following: vicinal diol, uracil, allyl ether, disulfide, restriction enzyme site, and 8-oxoguanine.

In any of the examples shown in FIG. 5A through FIG. 5D, the attachment of the primers 34, 36 and 38, 40 or 34′, 36′ and 38′, 40′ to the particle core 24 and to the polymeric hydrogel 30 leaves a template-specific portion of the primers 34, 36 and 38, 40 or 34′, 36′ and 38′, 40′ free to anneal to its cognate template and the 3′ hydroxyl group free for primer extension.

Referring back to FIG. 4A through FIG. 4D, this example method begins with the precursor structure 62, which includes the base support 16; and the reversibly swellable resin 18 positioned over the base support 16 and having the multi-depth depressions 20′ defined therein. The method includes exposing the precursor structure 62 to a grafted particle solution; allowing the grafted particle solution to incubate in the precursor structure 62, whereby a grafted particle 50 (e.g., 50A, 50B, 50C, 50D) settles into the deep portion 52; introducing a predetermined liquid, thereby swelling the reversibly swellable resin 18 so that the first opening dimension D₁ is reduced to a second opening dimension D₂ and the grafted particle 50 becomes trapped in the deep portion 52; washing out non-trapped grafted particles; and selectively introducing a polymeric hydrogel (e.g., pre-grafted polymer 56) to a surface 58 at the shallow portion 54 of the multi-depth depression 20′ while the grafted particle 50 is present in the deep portion 52.

The grafted particle solution includes any example of the grafted particle 50 (e.g., 50A, 50B, 50C, or 50D) disclosed herein dispersed or suspended in a liquid carrier that will not swell the resin 18. The liquid carrier of the grafted particle solution is any organic solvent to which the grafted particles are inert. In this example, the grafted particle solution is the source of the grafted particles 50.

Once the grafted particle solution and the precursor structure 62 are placed in contact with one another, the grafted particle solution is allowed to incubate. In an example, the grafted particle solution may be allowed to incubate for a time period ranging from about 5 seconds to about 5 minutes. During incubation, at least some of the grafted particles 50 settle into the deep portions 52 of at least some of the multi-depth depressions 20′.

Then, a predetermined liquid, such as water, an alcohol, an ionic liquid, or a buffer with a suitable pH, is introduced. During this incubation period, the reversibly swellable resin 18 swells, which causes the first opening dimension D₁ of the deep portion 52 to reduce to the second opening dimension D₂. The swelled resin 18 traps the grafted particles 50 that have settled in the deep portions 52.

It is to be understood that the overall opening dimension of the multi-depth depression 20′ may also narrow as a result of swelling. However, because the opening of the multi-depth depression 20′ expands over both the deep and shallow portions 52, 54, any grafted particles 50 that overly the particles 50 trapped in the deep portion 52 or that overly the shallow portion 54 may be removed during a wash cycle. In other words, the diameter of the grafted particles 50 is smaller than the narrowed opening of the multi-depth depression 20′, and thus these particles 50 can be removed. Thus, a wash cycle may be performed to remove the non-trapped grafted particles 50 from the precursor structure 62. This structure is shown in FIG. 4B.

As shown in FIG. 4C, the method then includes selectively introducing the pre-grafted polymer 56 to a surface 58 at the shallow portion 54 of the multi-depth depression 20′ while the grafted particle 50 is trapped in the deep portion 52. In this example, any example of the pre-grafted polymer 56 (e.g., 56A, 56B, 56C, 56D) may be applied using any suitable deposition technique under high ionic strength conditions (e.g., in the presence of 10×PBS, NaCl, KCl, etc.). A curing process, as described herein, may be performed after deposition. When the deposition of the pre-grafted polymer 56 is performed under high ionic strength, the pre-grafted polymer 56 does not deposit on or adhere to the grafted particle 50. As such, the pre-grafted polymer 56 does not contaminate the grafted particle 50.

The pre-grafted polymer 56 may then be removed from the interstitial regions 28 using an example of the polishing process described herein. The resulting patterned structure 14″ is shown in FIG. 4D. In some instances, polishing may be performed to remove at least some of the pre-grafted polymer 56 from the sidewalls of the multi-depth depression 20′ without removing it from the surface 58 at the shallow portion 54. The patterned structure 14″ shown in FIG. 4D may be used in a sequencing operation as shown (e.g., as an open wafer), or it may be bonded to a lid (not shown) to form a flow cell 10 having the architecture represented by FIG. 4D within each flow channel 12. In this example, the patterned structure 14″ may be exposed to enough of an aqueous solution or another suitable stimulus during the bonding process to ensure that the particles 50 do not get released.

Throughout the method shown in FIG. 4A through FIG. 4D, the structure 62, 14″ is exposed to the aqueous stimulus, or another suitable stimulus, to ensure that the resin 18 is maintained in the swollen state and the grafted particles 50 remain trapped.

While the method of FIG. 4A through FIG. 4D has been described using the pre-grafted polymer 56 (which includes any of 56A, 56B, 56C, or 56D), it is to be understood that the polymeric hydrogel 30 (without the primers 38, 40 or 38′, 40′ grafted thereto) may be selectively applied to the interstitial regions 28 and the surfaces 58 in the shallow portions 54 of each multi-well depression 20′ and then polished from the interstitial regions 28. In this example then, the primers 38, 40 or 38′, 40′ are grafted after the polymeric hydrogel 30 is applied and polished from the interstitial regions 28. Because the grafted particle 50 is already in place in the deep portion 52, primer 38, 40 or 38′, 40′ grafting may be performed as long as i) the polymeric hydrogel 30 has different functional groups (than particle core 24) for attaching the primers 38, 40 or 38′, 40′ or ii) any unreacted functional groups of the particle core 24 have been quenched, e.g., using the Staudinger reduction to generate amines or an additional click reaction with a passive molecule such as hexynoic acid.

The flow cell 10 formed with the patterned structure 14″ may be used for simultaneous paired end sequencing.

For this analysis, a template strand solution, including library templates dispersed in a liquid carrier, is introduced into the flow cell. Any example of the liquid carrier set forth herein may be used in the template strand solution. The template strands (library templates) present in the template strand solution may be prepared from any nucleic acid sample (e.g., a DNA sample or an RNA sample) as described herein.

A template strand hybridizes to one of the primers 34, 36, 38, 40 or 34′, 36′, 38′, 40′ that are immobilized in the multi-depth depression 20′. Amplification of the seeded template strand(s) in the depressions 20′ may be initiated to form clusters of the seeded template strands across both the grafted particle 50 and the (pre-)grafted polymer 56. Because the primer sets of the grafted particle 50 and the (pre-)grafted polymer 56 include orthogonally cleavable oligonucleotide pairs, amplification can span both the grafted particle 50 and the (pre-)grafted polymer 56. In an example, the grafted particle 50 may have un-cleavable first template (e.g., forward) strands and cleavable second template (reverse) strands attached thereto, while the (pre)-grafted polymer 56 may have cleavable first template (e.g., forward) strands and un-cleavable second template (reverse) strands attached thereto. The cleavable first and second template strands may then be removed by introducing a chemical agent or an enzymatic cleaving agent depending on the cleavage sites 42 and 42′ or 44. After cleavage, the un-cleavable first template (e.g., forward) strands remain on the particle 50, and the un-cleavable second template (e.g., reverse) strands remain on the polymer 56. Thus, one type of template strands (e.g., forward strands) are clustered on the particle 50 and the other type of template strands (e.g., reverse strands) are clustered on the polymer 56. This enables distinguishable read 1 and read 2 signals to be obtained simultaneously.

Throughout this method, it is to be understood that the template strand solution, the wash fluid, and the sequencing reagents (e.g., sequencing primer fluid, incorporation mix, and cleavage mix) maintain the aqueous condition within the flow cell, and thus keep the reversibly swellable resin 18 in the swelled state throughout the analysis.

After the analysis, the stimulus may be removed or an orthogonal stimulus may be applied to de-swell and thus contract the reversibly swellable resin 18. The removal of the stimulus or the application of the orthogonal stimulus causes the reversibly swellable resin 18 to revert back to the non-swelled stated, where the deep portion 52 of the multi-depth depressions 20′ have the first (larger) opening dimension D₁. In other words, removing the stimulus or applying an orthogonal stimulus after the analysis causes the reversibly swellable resin 18 to contract so that the second opening dimension D₂ is increased to the first opening dimension D₁. This frees the now-sequenced particles, enabling them to be washed from the flow cell 10. This example flow cell 10 may be reused, for example, when the polymer 56 includes biotin, because streptavidin bound primers 34, 36, 38, 40 or 34′, 36′, 38′, 40′ can be released and replenished.

In any of the examples disclosed herein, it is to be understood that the first opening dimension D₁ corresponds to any of the depression dimensions (e.g., opening area, depth, or diameter or length and width) set forth herein, and the second opening dimension D₂ is smaller than the first opening dimension D₁. The second opening dimension D₂ may vary from one swelling event to another swelling event, depending, in part, upon the stimulus used.

To further illustrate the present disclosure, examples are given herein. It is to be understood that these examples are provided for illustrative purposes and are not to be construed as limiting the scope of the present disclosure.

### NON-LIMITING WORKING EXAMPLES

### Example 1

An example of the reversibly swellable resin was prepared with poly(ethylene glycol) diglycidyl ether, epoxycyclohexylethyl polysilsesquioxane, and glycidyl polysilsesquioxane. The monomers and a surface additive were dissolved in a solvent. The resin composition was applied to a glass substrate and was imprinting with a working stamp. While the working stamp was in place, the resin composition was UV cured. Several imprinted films were prepared.

The increased surface energy of the imprinted films was measured by recording the contact angle. The contact angle was about 75° for each film, which was reduced when compared to a similar resin composition made without the poly(ethylene glycol) diglycidyl ether (contact angles >85°). The imprinted films displayed an instant (<1 s) color change, which corresponded with a change in film thickness properties, when exposed to either high humidity or water.

### Additional Notes

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it is to be understood that the disclosed examples may be modified. Therefore, the foregoing description is to be considered non-limiting.

What is claimed is:

1. A flow cell, comprising:
a base support;
a reversibly swellable resin positioned over the base support, the reversibly swellable resin including at least one hydrophilic monomer selected from the group consisting of a poly(ethylene glycol) based monomer, poly(propylene glycol) based monomer, an acid-containing monomer, and combinations thereof; and
a depression defined in the reversibly swellable resin, the depression having a first opening dimension when the reversibly swellable resin is in a non-swelled stated and having a second opening dimension, that is smaller than the first opening dimension, when the reversibly swellable resin is in a swelled stated.

2. The flow cell as defined in claim 1, wherein the reversibly swellable resin includes from 0.5% to 20% of the hydrophilic monomer.

3. The flow cell as defined in claim 1, wherein the reversibly swellable resin includes at least one epoxy polyhedral oligomeric silsesquioxane monomer copolymerized with the hydrophilic monomer.

4. The flow cell as defined in claim 1, further comprising a polymeric hydrogel covalently attached to the reversibly swellable resin, wherein the reversibly swellable resin includes at least one additional monomer copolymerized with the hydrophilic monomer, and wherein the at least one additional monomer includes a functional group to covalently attach to the polymeric hydrogel.

5. The flow cell as defined in claim 4, wherein the functional group is selected from the group consisting of an alkyne, a diene, an azide, and an amine.

6. The flow cell as defined in claim 4, further comprising a single primer set grafted to the polymeric hydrogel.

7. The flow cell as defined in claim 1, further comprising a polymeric hydrogel non-covalently attached to the reversibly swellable resin.

8. The flow cell as defined in claim 1, wherein the depression is a multi-depth depression including a deep portion and a shallow portion adjacent to the deep portion.

9. The flow cell as defined in claim 8, further comprising:
a grafted particle confined within the deep portion, the grafted particle having a first primer set grafted to a core particle; and
a pre-grafted polymer positioned on a surface at the shallow portion, the pre-grafted polymer having a second primer set that is orthogonal to the first primer set grafted to a polymeric hydrogel.

10. A method, comprising:
introducing a pre-clustered particle solution into a flow cell including:
a base support;
a reversibly swellable resin positioned over the base support, the reversibly swellable resin including at least one hydrophilic monomer selected from the group consisting of a poly(ethylene glycol) based monomer, poly(propylene glycol) based monomer, and combinations thereof; and
a depression defined in the reversibly swellable resin, the depression having a first opening dimension when the pre-clustered particle solution is introduced;
allowing the pre-clustered particle solution to incubate in the flow cell, whereby a pre-clustered particle settles into the depression;
exposing the reversibly swellable resin to a stimulus, thereby causing the first opening dimension to reduce to a second opening dimension and trapping the pre-clustered particle in the depression;
washing out non-trapped pre-clustered particles; and
maintaining the stimulus exposure at least until an analysis involving the trapped pre-clustered particle is performed.

11. The method as defined in claim 10, wherein the stimulus is selected from the group consisting of a predetermined liquid and a liquid having a predetermined pH.

12. The method as defined in claim 11, wherein:
the stimulus is the predetermined liquid;
the predetermined liquid is water, an alcohol, or an ionic liquid;
exposing the reversibly swellable resin to the stimulus takes place when the pre-clustered particle solution is introduced into the flow cell; and
maintaining the stimulus exposure involves introducing at least one aqueous reagent during the analysis.

13. The method as defined in claim 11, wherein:
the stimulus is the liquid having the predetermined pH;
exposing the reversibly swellable resin to the stimulus takes place when the pre-clustered particle solution is introduced into the flow cell; and
maintaining the stimulus exposure involves introducing at least one aqueous reagent having the predetermined pH during the analysis.

14. The method as defined in claim 11, further comprising removing the stimulus after the analysis, whereby the reversibly swellable resin contracts so that the second opening dimension is increased to the first opening dimension.

15. A method, comprising:
introducing a predetermined liquid into a flow cell including:
a base support;
a reversibly swellable resin positioned over the base support, the reversibly swellable resin including at least one hydrophilic monomer selected from the group consisting of a poly(ethylene glycol) based monomer, poly(propylene glycol) based monomer, and combinations thereof;
a depression defined in the reversibly swellable resin, the depression having a first opening dimension when the predetermined liquid is introduced;
a polymeric hydrogel positioned in the depression; and
a single primer set attached to the polymeric hydrogel;
allowing the predetermined liquid to incubate in the flow cell, whereby the reversibly swellable resin swells so that the first opening dimension is reduced to a second opening dimension; and
introducing a template strand solution into the flow cell while the reversibly swellable resin is swelled.

16. The method as defined in claim 15, wherein the predetermined liquid is water, water and a buffer, alcohol, or an ionic liquid.

17. The method as defined in claim 15, wherein the predetermined liquid is allowed to incubate for a time period ranging from about 5 seconds to about 5 minutes before the template strand solution is introduced into the flow cell.

18. A method comprising:
exposing a precursor structure to a grafted particle solution, the precursor structure including:
a base support;
a reversibly swellable resin positioned over the base support, the reversibly swellable resin including at least one hydrophilic monomer selected from the group consisting of a poly(ethylene glycol) based monomer, poly(propylene glycol) based monomer, and combinations thereof; and
a multi-depth depression defined in the reversibly swellable resin, the multi-depth depression including a deep portion and a shallow portion adjacent to the deep portion, the deep portion having a first opening dimension when the grafted particle solution is introduced;
allowing the grafted particle solution to incubate in the precursor structure, whereby a grafted particle settles into the deep portion;
exposing the precursor structure to a predetermined liquid, thereby swelling the reversibly swellable resin so that the first opening dimension is reduced to a second opening dimension and the grafted particle becomes trapped in the deep portion;
washing out non-trapped grafted particles; and
selectively introducing a polymeric hydrogel to a surface at the shallow portion of the multi-depression while the grafted particle is present in the deep portion.

19. The method as defined in claim 18, wherein:
the polymeric hydrogel is a pre-grafted polymeric hydrogel; and
a first primer set of the grafted particle is orthogonal to a second primer set of the pre-grafted polymeric hydrogel.

20. The method as defined in claim 18, further comprising grafting a first primer set to the selectively introduced polymeric hydrogel, wherein the first primer set is orthogonal to a second primer set of the grafted particle.


SEQUENCE LISTING (13 sequences)

SEQ ID NO: 1 - DNA, 29 bp, synthetic construct
  source 1..29: mol_type = other DNA
  modified_base 23: mod_base = OTHER; note = URACIL
aatgatacggcgaccaccgagatctacac

SEQ ID NO: 2 - DNA, 24 bp, synthetic construct
  source 1..24: mol_type = other DNA
  modified_base 22: mod_base = OTHER; note = 8-oxoguanine
caagcagaagacggcatacganat

SEQ ID NO: 3 - DNA, 24 bp, synthetic construct
  source 1..24: mol_type = other DNA
  modified_base 20: mod_base = OTHER; note = 8-oxoguanine
caagcagaagacggcatacnagat

SEQ ID NO: 4 - DNA, 24 bp, synthetic construct
  source 1..24: mol_type = other DNA
  modified_base 20: mod_base = OTHER; note = 8-oxoguanine
  modified_base 22: mod_base = OTHER; note = 8-oxoguanine
caagcagaagacggcatacnanat

SEQ ID NO: 5 - DNA, 29 bp, synthetic construct
  source 1..29: mol_type = other DNA
  misc_difference 23: note = allyl-T
aatgatacggcgaccaccgaganctacac

SEQ ID NO: 6 - DNA, 35 bp, synthetic construct
  source 1..35: mol_type = other DNA
gctggcacgtccgaacgcttcgttaatccgttgag

SEQ ID NO: 7 - DNA, 35 bp, synthetic construct
  source 1..35: mol_type = other DNA
ctcaacggattaacgaagcgttcggacgtgccagc

SEQ ID NO: 8 - DNA, 35 bp, synthetic construct
  source 1..35: mol_type = other DNA
cgtcgtctgccatggcgcttcggtggatatgaact

SEQ ID NO: 9 - DNA, 35 bp, synthetic construct
  source 1..35: mol_type = other DNA
agttcatatccaccgaagcgccatggcagacgacg

SEQ ID NO: 10 - DNA, 35 bp, synthetic construct
  source 1..35: mol_type = other DNA
acggccgctaatatcaacgcgtcgaatccgcaact

SEQ ID NO: 11 - DNA, 35 bp, synthetic construct
  source 1..35: mol_type = other DNA
agttgcggattcgacgcgttgatattagcggccgt

SEQ ID NO: 12 - DNA, 34 bp, synthetic construct
  source 1..34: mol_type = other DNA
gccgcgttacgttagccggactattcgatgcagc

SEQ ID NO: 13 - DNA, 34 bp, synthetic construct
  source 1..34: mol_type = other DNA
gctgcatcgaatagtccggctaacgtaacgcggc